(19) United States
(12) Patent Application Publication
(10) Pub. No.: US 2016/0117730 A1
(43) Pub. Date: Apr. 28, 2016

(54) SYSTEM AND METHOD FOR USER CONTROLLED INTERACTIVE ONLINE ADVERTISEMENTS

(71) Applicant: ExpertBeacon, Inc., Littleton, CO (US)

(72) Inventors: Timothy Nats, Highland Ranch, CO (US); Mark Law, Woodinville, WA (US)

(73) Assignee: ExpertBeacon, Inc., Littleton, CO (US)

(21) Appl. No.: 14/989,514

(22) Filed: Jan. 6, 2016

Related U.S. Application Data
(63) Continuation of application No. PCT/US2014/045802, filed on Jul. 8, 2014.
Application No. PCT/US2014/045802 is a continuation of application No. PCT/US2014/045803, filed on Jul. 8, 2014.
(60) Provisional application No. 61/843,782, filed on Jul. 8, 2013.
(60) Provisional application No. 61/865,548, filed on Aug. 13, 2013.
(60) Provisional application No. 61/843,782, filed on Jul. 8, 2013.
(60) Provisional application No. 61/865,548, filed on Aug. 13, 2013.

(51) Int. Cl. G06Q 30/02

(52) U.S. Cl. CPC G06Q 30/0257; G06Q 30/0277

(57) ABSTRACT

Some embodiments include a system for user controlled interactive online advertisements. Other embodiments of related systems and methods are also disclosed.

### CROSS-REFERENCE TO RELATED APPLICATIONS

This application is a continuation of International Patent Application No. PCT/US2014/045802, filed Jul. 8, 2014, and is a continuation of International Patent Application No. PCT/US2014/045803, filed Jul. 8, 2014. International Patent Application No. PCT/US2014/045802 and International Patent Application No. PCT/US2014/045803 each claim the benefit of U.S. Provisional Patent Application No. 61/843,782, filed Jul. 8, 2013, and U.S. Provisional Patent Application No. 61/865,548, filed Aug. 13, 2013. International Patent Application No. PCT/US2014/045802, International Patent Application No PCT/US2014/045803, U.S. Provisional Patent Application No. 61/843,782 and U.S. Provisional Patent Application No. 61/865,548 are incorporated herein by reference in their entirety.

### FIELD OF THE INVENTION

This invention relates generally to systems of advertising and related methods, and relates more particularly to such systems that provide controlled interactive online advertising and related methods.

### DESCRIPTION OF THE BACKGROUND

The manner in which online advertisements (e.g., paid placements of advertising content contained within an advertising unit at a web page or software application (e.g., a mobile software application) and provided over a computer network) are presented is conventionally determined by a publisher or an advertising system. Online advertisements can be displayed in a fixed or dynamic manner and often contain hyperlinks that, when selected by a user, can open a new web page displaying related advertising content. Some online advertisements, such as, for example, online advertisements displaying rich media (e.g., animated images), allow a user to enlarge or shrink a size of the online advertisements, and some online advertisements allow the user to stop, pause, mute audio, and play video advertising content at the online advertisement, but none allow the user to change the advertising content (e.g., information) presented in the advertisement. For example, there are no filters, variables, options, or settings that the user can control within such online advertisements that, when selected or modified, are operable to change the advertising content of the online advertisements or to modify a layout (e.g., arrangement) of the advertising content of the online advertisements.

Accordingly, a need or potential for benefit exists for a system that allows users of a web page or software application to interact with online advertisements contained within the advertising unit of the web page or software application to change the advertising content and/or to modify a layout of the online advertisements.

### BRIEF DESCRIPTION OF THE DRAWINGS

To facilitate further description of the embodiments, the following drawings are provided in which:

FIG. 1 illustrates a representative block diagram of a system for providing content (e.g., providing advertising), according to an embodiment;

FIG. 2 illustrates a representative block diagram of exemplary content of a web page or a software application (e.g., mobile software application) created using the system of FIG. 1;

FIG. 3 illustrates exemplary content, according to an embodiment;

FIG. 4 illustrates exemplary content, according to an embodiment;

FIG. 5 illustrates a flow chart for an embodiment of a method of providing content to a user;

FIG. 6 illustrates a computer system that is suitable for implementing an embodiment of a content providing system and/or one or more user devices of the system of FIG. 1;

FIG. 7 illustrates a representative block diagram of an example of the elements included in the circuit boards inside chassis of the computer of FIG. 6;

FIG. 8 illustrates a representative block diagram of a system for providing content (e.g., providing advertising), according to an embodiment;

FIG. 9 illustrates a representative block diagram of exemplary content of a web page or a software application (e.g., mobile software application) created using the system of FIG. 8;

FIG. 10 illustrates exemplary content, according to an embodiment;

FIG. 11 illustrates an exemplary interface at which advertiser(s) of the system of FIG. 8 can select suggested advertisement classification(s);

FIG. 12 illustrates another exemplary interface at which advertiser(s) of the system of FIG. 8 can select suggested advertisement classification(s);

FIG. 13 illustrates a flow chart for an embodiment of a method of providing content to a user;

FIG. 14 illustrates an exemplary activity of providing a user with the content comprising the primary content and an advertising unit comprising one or more advertisement window(s), according to the embodiment of FIG. 13; and

FIG. 15 illustrates an exemplary activity of establishing at least one classification condition, according to the embodiment of FIG. 13.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

The terms “couple,” “coupled,” “couples,” “coupling,” and the like should be broadly understood and refer to connecting two or more elements or signals, electrically, mechanically and/or otherwise. Two or more electrical elements may be electrically coupled but not be mechanically or otherwise coupled; two or more mechanical elements may be mechanically coupled, but not be electrically or otherwise coupled; two or more electrical elements may be mechanically coupled, but not be electrically or otherwise coupled. Coupling may be for any length of time, e.g., permanent or semi-permanent or only for an instant.

“Electrical coupling” and the like should be broadly understood and include coupling involving any electrical signal, whether a power signal, a data signal, and/or other types or combinations of electrical signals. “Mechanical coupling” and the like should be broadly understood and include mechanical coupling of all types.

The absence of the word “removably,” “removable,” and the like near the word “coupled,” and the like does not mean that the coupling, etc. in question is or is not removable.

### DETAILED DESCRIPTION OF EXAMPLES OF EMBODIMENTS

Many embodiments include a system for providing one or more web pages to one or more users. Each of the one or more web pages comprises primary content and one or more interactive advertisements. The system comprises a processor and a non-transitory memory storage device operable to store computer instructions configured to run on the processor and perform acts of generating the one or more interactive advertisements based upon one or more advertising elements; generating the primary content based upon one or more primary content elements; generating the one or more web pages based upon the primary content and the one or more interactive advertisements; communicating with the one or more users to receive one or more requests from the one or more users; and based upon the one or more requests from the one or more users, altering at least one of: a content of the one or more interactive advertisements, a format of the one or more interactive advertisements, a content of the primary content, or a format of the primary content.

Various embodiments include a method for providing advertisements on a web page. At least part of the method can be implemented via execution of one or more computer instructions configured to run at a processor. The method can comprise: executing one or more first computer instructions configured to receive a first request from a user for the web page; executing one or more second computer instructions configured to provide the user with the web page, the web page comprising: (i) primary content, and (ii) one or more interactive advertisements; executing one or more third computer instructions configured to receive a second request from the user to alter a first one of the one or more interactive advertisements; and after executing the one or more third computer instructions, executing one or more fourth computer instructions configured to alter the first one of the one or more interactive advertisements, the first one of the one or more interactive advertisements comprising a content. Further, the one or more computer instructions can comprise the one or more first computer instructions, the one or more second computer instructions, the one or more third computer instructions, and the one or more fourth computer instructions.

Further embodiments include a method for providing advertisements at a mobile software application. At least part of the method can be implemented via execution of one or more computer instructions configured to run at a processor. The mobile software application can include primary content and one or more interactive advertisements. Meanwhile, the method can comprise: executing one or more first computer instructions configured to receive a request from the user to alter a first one of the one or more interactive advertisements; and after executing the one or more first computer instructions, executing one or more second computer instructions configured to alter the first one of the one or more interactive advertisements, the first one of the one or more interactive advertisements comprising a content. Further, the one or more computer instructions can comprise the one or more first computer instructions and the one or more second computer instructions.

Other embodiments include a system for providing one or more web pages to one or more users. Each of the one or more web pages comprises primary content and one or more interactive advertisements. The system comprises an advertisement module configured to run on a processing module and further configured to generate the one or more interactive advertisements based upon one or more advertising elements. Further, the system comprises a content module configured to run on the processing module and further configured to generate the primary content based upon one or more primary content elements. Meanwhile, the system comprises a web page creation module configured to run on the processing module and further configured to generate the one or more web pages based upon the primary content and the one or more interactive advertisements. Also, the system comprises a communications module configured to run on the processing module and further configured to communicate with the one or more users. Further still, the system comprises a modification module configured to run on the processing module and further configured to alter based upon one or more requests from the one or more users at least one of: a content of the one or more interactive advertisements, a format of the one or more interactive advertisements, a content of the primary content, or a format of the primary content.

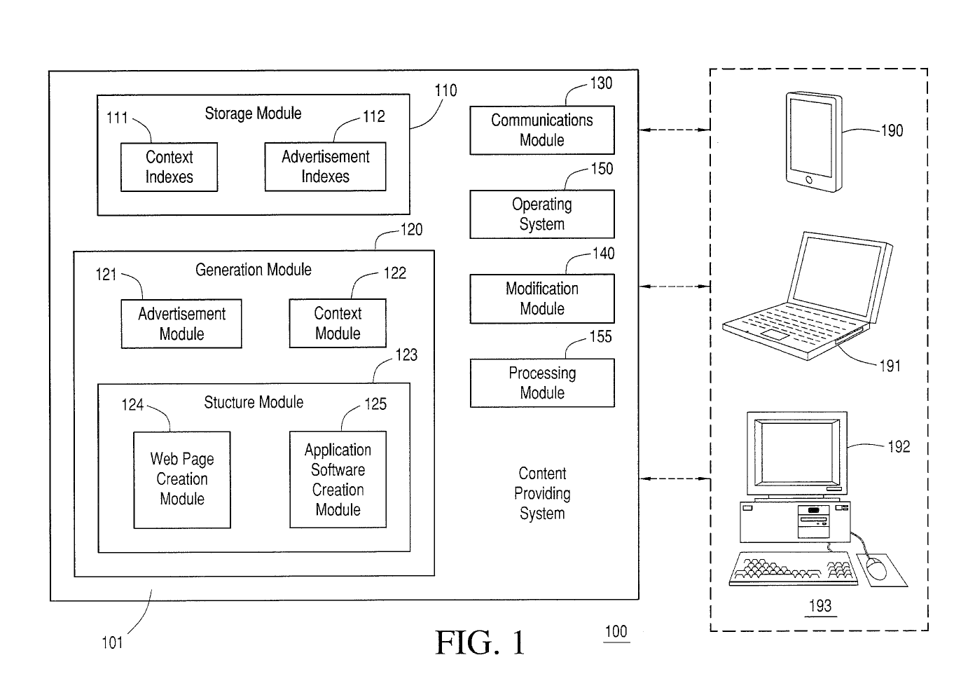

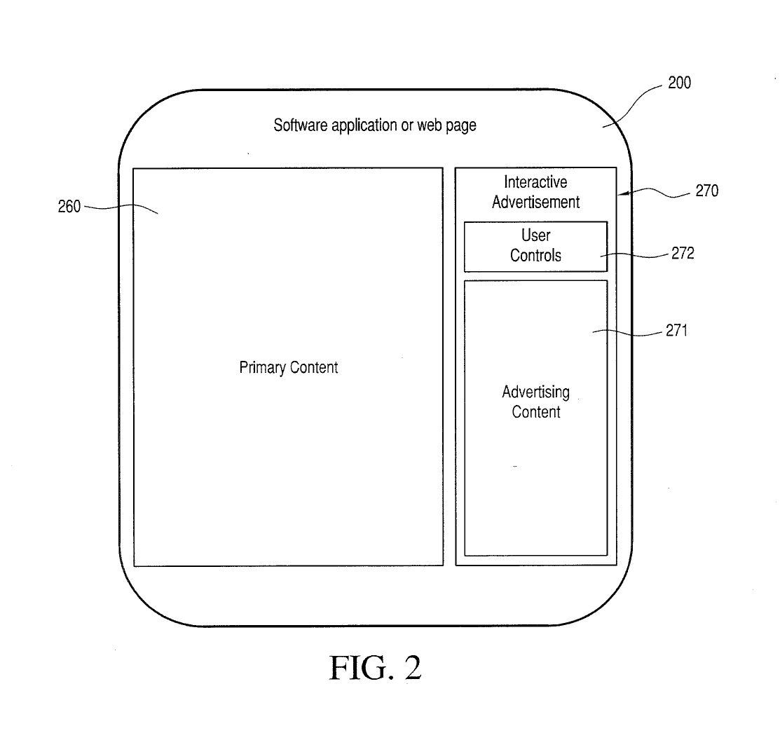

Turning to the drawings, FIG. 1 illustrates a representative block diagram of a system 100 for providing content, according to an embodiment. In these or other embodiments, the content can be provided at one or more web pages, at a software application (e.g., a mobile software application), at a television, at a radio broadcast, and/or any other suitable content providing medium. In some embodiments, system 100 can be implemented to provide the content to one or more users of system 100 at one or more user devices 193 (e.g., a user device 190, a user device 191, and/or a user device 192), as discussed below. System 100 is merely exemplary and is not limited to the embodiments presented herein. System 100 can be employed in many different embodiments or examples not specifically depicted or described herein. Meanwhile, FIG. 2 illustrates a representative block diagram of exemplary content 200 of a web page or a software application (e.g., mobile software application) created using system 100 (FIG. 1). Accordingly, the content provided by system 100 (FIG. 1) can be similar or identical to content 200.

Although system 100 can be implemented to provide content at any suitable web page(s) and/or software application (e.g., mobile software application), in many embodiments, for example, system 100 can be implemented to provide content at one or more web pages of a travel website. Further, a user of system 100 can enter the departure and arrival location on a web page to be presented flight options between the departure and arrival location. Meanwhile, on a web page showing the flight options, there could be an interactive advertisement paid for by a hotel chain (e.g., Hilton® Hotels) that provides (e.g., displays) advertising content of one or more hotels located at or near the arrival location. The interactive advertisement can include one or more user controls that provide (e.g., display) “change location for hotels.” Accordingly, if the user of system 100 is in fact traveling to another location (e.g., destination city) other than the arrival location, the user of system 100 can operate the user control(s) to change the location inside the advertisement to the other location. Meanwhile, operating the user control(s) to change the location can cause the advertising content to change in the interactive advertisement to one or more hotels located at or near the other location while maintaining the departure and arrival flight information on the web page (e.g., without refreshing, reloading, or reseeding the web page). In these or other embodiments, system 100 can (i) expand the existing interactive advertisement to include advertising content of one or more rental car options from which to choose and/or (ii) provide a new advertisement with advertising content including the one or more rental car options from which to choose upon recognizing the arrival location is within some distance from the other location.

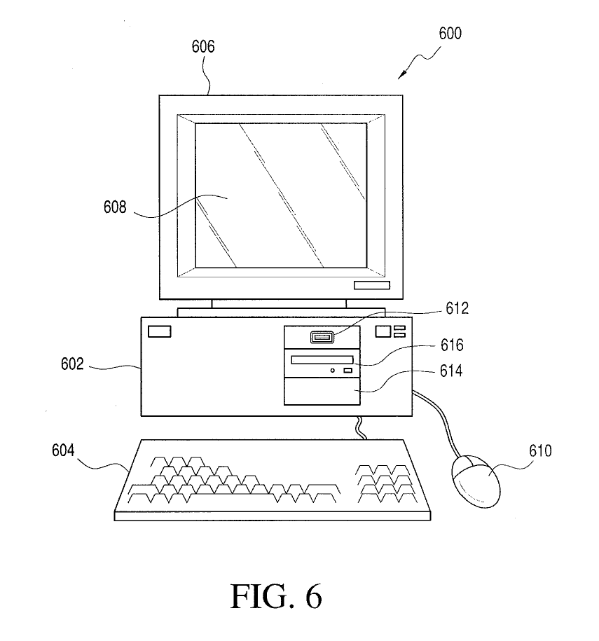

Referring to FIG. 1, in many embodiments, system 100 can comprise a content providing system 101. Content providing system 101 can provide the content to the user(s) of system 100 at user device(s) 193 (e.g., user device 190, user device 191, and/or user device 192) of system 100 and/or the users of system 100. In many embodiments, content providing system 101 can comprise a computer system. In these or other embodiments, one or more of user device(s) 193 (e.g., user device 190, user device 191, and/or user device 192) each can comprise a computer system. The computer system of content providing system 101 and/or user device(s) 193 (e.g., user device 190, user device 191, and/or user device 192) can be similar or identical to computer system 600 (FIG. 6).

In some embodiments, system 100 can comprise user device(s) 193 (e.g., user device 190, user device 191, and/or user device 192). Further, in these or other embodiments, content providing system 101 can comprise a processing module 155, a storage module 110, a generation module 120, a communications module 130, a modification module 140, and/or an operating system 150.

In implementation, processing module 155 can comprise one or more processors. As used herein, a “processor” can mean any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions (e.g., running computer software).

Meanwhile, storage module 110 can comprise one or more non-volatile computer memory storage devices configured to store computer software (e.g., computer instructions) and/or data (e.g., data related to system 100, content providing /system 101, and/or content 200 (FIG. 2)) on a temporary and/or permanent basis for use by system 100, content providing system 101, and/or processing module 155. Notably, content providing system 101 also can include one or more volatile computer memory storage devices.

In many embodiments, at least part of generation module 120, communications module 130, modification module 140, and/or operating system 150 can be implemented as computer software. Accordingly, in these or other embodiments, at least part of generation module 120, communications module 130, modification module 140, and/or operating system 150 can be configured to run at processing module 190 and/or to be stored at storage module 110. In some embodiments, at least part of generation module 120, communications module 130, modification module 140, and/or operating system 150 also can be configured to be stored at the volatile computer memory storage devices of content providing system 101 as may be necessary to performed the desired functions of system 100 and/or content providing system 101.

As a general matter, communications module 130 can be configured to permit communication between processing module 155 and storage module 110, and between content providing system 101 and user device(s) 193 (e.g., user device 190, user device 191, and/or user device 192) of system 100. For example, communications module 130 can permit processing module 155 to call computer software (e.g., at least part of generation module 120, communications module 130, modification module 140, and/or operating system 150) stored at storage module 110 and/or data stored at storage module 110 for operation of system 100 and/or content providing system 101. Further, communications module 130 can permit data generated at processing module 155 to be communicated to storage module 110 for storage. Further still, communications module 130 can permit any user device(s) 193 (e.g., user device 190, user device 191, and/or user device 192) of system 100 to provide inputs (e.g., commands) to processing module 155 and/or storage module 110, and can provide data generated by processing module 155 to be output to user device(s) 193 (e.g., user device 190, user device 191, and/or user device 192). The input(s) can be provided by any suitable input mechanism(s) (e.g., a keyboard, a 762697.5 10 mouse, a touch screen display, etc.), and the output(s) can be provided at any suitable output mechanism(s) (e.g., a display, a speaker, etc.).

Although at least part of communications module 130 can be implemented as computer software, at least part of communications module 130 can also be implemented as any suitable hardware configured to perform the desired communication for system 100 and/or content providing system 101. For example, communications module 130 can comprise (a) one or more transmission components configured to provide wired communication (e.g., one or more data buses, such as, for example, universal serial bus(es); one or more networking cables, such as, for example, coaxial cable(s), optical fiber cable(s), and/or twisted pair cable(s); any other suitable data cable, etc.) and/or (b) one or more transmission components configured to provide wireless communication (e.g., one or more radio transceivers, one or more infrared transceivers, etc.). Also, communications module 130 can comprise one or more networking components (e.g., modulator-demodulator components, gateway components, etc.). Further, communications module 130 can be configured to operate using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), Powerline network protocol(s), etc.). Exemplary PAN protocol(s) can comprise Bluetooth, Zigbee, Wireless Universal Serial Bus (USB), Z-Wave, etc.; exemplary LAN and/or WAN protocol(s) can comprise Institute of Electrical and Electronic Engineers (IEEE) 802.3, IEEE 802.11, etc.; and exemplary wireless cellular network protocol(s) can comprise Global System for Mobile Communications (GSM), General Packet Radio Service (GPRS), Code Division Multiple Access (CDMA), Evolution-Data Optimized (EV-DO), Enhanced Data Rates for GSM Evolution (EDGE), 3GSM, Digital Enhanced Cordless Telecommunications (DECT), Digital AMPS (IS-136/Time Division Multiple Access (TDMA)), Integrated Digital Enhanced Network (iDEN), etc. The software and/or hardware of communications module 130 can be dependent on the network topologies and/or protocols in use, and vice versa.

In various embodiments, operating system 150 can comprise computer software configured to manage the hardware and computer software resources of a computer and/or a computer network. Operating system 150 can perform basic tasks such as, for example, controlling and allocating memory, prioritizing the processing of instructions, controlling input and output devices, facilitating networking, and managing files. Examples of common operating systems for a computer include Microsoft® Windows, Mac® operating system (OS), UNIX® OS, and Linux® OS.

In some embodiments, when content providing system 101 comprises a computer system, the computer system can comprise a single computer, a single server, or a cluster or collection of servers. Typically, a cluster or collection of servers can be used when the demands by content providing system 101 are beyond the reasonable capability of a single computer or a single server. In many embodiments, the servers in the cluster or collection of servers are interchangeable from the perspective of the users of system 100.

Meanwhile, although processing module 155, storage module 110, generation module 120, communications module 130, modification module 140, and/or operating system 150 are described herein generally as being located at part of a single computer or server, in many embodiments, parts of any of processing module 155, storage module 110, generation module 120, communications module 130, modification module 140, and/or operating system 150 may be spread between and/or possibly overlap at multiple servers when the computer system of content providing system 101 comprises a cluster of collection of servers. For example, the computer system of content providing system 101 can comprise a first server comprising a first portion of one or more of processing module 155, storage module 110, generation module 120, communications module 130, modification module 140, and/or operating system 150. Meanwhile, one or more second servers can comprise a second, possibly overlapping, portion of processing module 155, storage module 110, generation module 120, communications module 130, modification module 140, and/or operating system 150.

Further, as discussed in greater detail below, generation module 120 can determine (e.g., generate) content (e.g., content 200 (FIG. 2)) to provide to the user(s) of system 100 at user device(s) 193 (e.g., user device 190, user device 191, and/or user device 192), and/or modification module 140 can alter content (e.g., content 200 (FIG. 2)) provided to the user(s) of system 100 at user device(s) 193 (e.g., user device 190, user device 191, and/or user device 192). Meanwhile, communications module 130 can provide the content determined by generation module 120 and/or altered by modification module 140 to the user(s) of system 100 at user device(s) 193 (e.g., user device 190, user device 191, and/or user device 192) for content providing system 101.

Turning ahead now to FIG. 2, content 200 can comprise primary content 260 and at least one interactive advertisement 270. Interactive advertisement(s) 270 can comprise advertising content 271 and/or one or more user controls 272.

In many embodiments, interactive advertisement(s) 270 can comprise online advertisements and can be part of one or more advertising units. Accordingly, in some examples, content 200 can comprise a web page viewable, such as, for example, at user device(s) 193 (e.g., user device 190, user device 191, and/or user device 192), using a web browser. In another example, content 200 can be content for a software application (e.g., a mobile software application), such as, for example, at user device(s) 193 (e.g., user device 190, user device 191, and/or user device 192). In use, advertisers can pay an owner or operator of content providing system 101 (FIG. 1) for the interactive advertisement(s) 270 using any suitable technique(s) (e.g., sponsorship, CPI (cost per impression), CPC (cost per click through), and/or CPA (cost per acquisition)).

Advertising content 271 can comprise text, images, video, and/or audio of interactive advertisement(s) 270. Meanwhile, user control(s) 272 can comprise any suitable input mechanism(s). However, in many embodiments, user controls 272 can be implemented as one or more graphical icons, indicators, etc.

In the example shown in FIG. 2, interactive advertisement(s) 270 can be part of a skyscraper advertising unit (e.g., an advertising unit in the shape of a tall vertical rectangle, often having dimensions of: 160 pixels wide by 600 pixels tall, or 120 pixels wide by 600 pixels tall, or 300 pixels wide by 600 pixels tall). However, interactive advertisement(s) 270 can be part of any suitable advertising unit formats (e.g., shape, size, etc.). For example, in the same or different embodiments, interactive advertisement(s) 270 can be part of a leader board advertising unit (e.g., an advertising unit in the shape of a horizontal rectangle, often having dimensions of: 728 pixels wide by 90 pixels tall, or 468 pixels wide by 60 pixels tall), a rectangular advertising unit (e.g., an advertising unit in the shape of a near-square, often having dimensions of 300 pixels wide by 250 pixels tall), etc. Further, interactive advertisement(s) 270 can comprise a text advertisement (e.g., an advertisement limited to text without images or other audio-visual content). In these embodiments, user controls 272 may also be limited to text provided (e.g., displayed) to the user(s) of system 100 (FIG. 1). For example, interactive advertisement 270 can be similar in design and layout to a Google® text advertisement, a Google® search result, or be similar in design and layout to other standard types of text advertisements and/or search results.

In some embodiments, when interactive advertisement(s) 270 comprise multiple interactive advertisements, each of interactive advertisement(s) 270 can comprise the same advertisement format. In other embodiments, when interactive advertisement(s) 270 comprise multiple interactive advertisements, one or more interactive advertisements of interactive advertisement(s) 270 can comprise a different advertisement format from one or more other interactive advertisements of interactive advertisement(s) 270.

Turning now back to FIG. 1, in many embodiments, storage module 110 can comprise (a) at least one content index 111 configured to store one or more content elements used to provide (e.g., generate) primary content (e.g., primary content 260 (FIG. 2)) of the content (e.g., content 200 (FIG. 2)) provided to the user(s) of system 100 at user device(s) 193 (e.g., user device 190, user device 191, and/or user device 192); and (b) at least one advertisement index 112 configured to store one or more advertising elements used to provide (e.g., generate) one or more interactive advertisements (e.g., interactive advertisement(s) 270 (FIG. 2)) of the content (e.g., content 200 (FIG. 2)) provided to the user(s) of system 100 at user device(s) 193 (e.g., user device 190, user device 191, and/or user device 192). Accordingly, the primary content of the content provided to the user(s) of system 100 at user device(s) 193 (e.g., user device 190, user device 191, and/or user device 192) can be similar or identical to primary content 260 (FIG. 2), and/or the interactive advertisement(s) of the content provided to the user(s) of system 100 at user device(s) 193 (e.g., user device 190, user device 191, and/or user device 192) can be similar or identical to interactive advertisement(s) 270 (FIG. 2). Meanwhile, these interactive advertisements can comprise advertising content and one or more user controls, which can be similar or identical to advertising content 271 (FIG. 2), and user control(s) 272 (FIG. 2), respectively.

In many embodiments, the content element(s) stored at content index(es) 111 can comprise one or more pieces of content (e.g., text, images, videos, audio, etc.) that cause the user(s) of system 100 to request the primary content (e.g., primary content 260 (FIG. 2)) of the content (e.g., content 200 (FIG. 2)) provided to the user(s) of system 100 at user device(s) 193 (e.g., user device 190, user device 191, and/or user device 192). For example, the content element(s) of a website that provides expert advice can include text, videos, and audios of expert advice relating to any suitable subject matter. In an example of a website about cats, the content element(s) can include information about cats, images of cats, videos of cats, the price of cats for purchase, etc.

In many embodiments, the advertising element(s) stored at advertisement index(es) 112 can comprise one or more element(s) of the one or more interactive advertisements (e.g., interactive advertisement(s) 270 (FIG. 2)) of the content (e.g., content 200 (FIG. 2)) provided to the user(s) of system 100 at user device(s) 193 (e.g., user device 190, user device 191, and/or user device 192). For example, the advertising element(s) can include the advertising content (e.g., advertising content 271 (FIG. 2)) of the interactive advertisement(s) and/or instructions (e.g., computer instructions) configured to create the user control(s) (e.g., user control(s) 272 (FIG. 2)) of the interactive advertisement(s).

In implementation, content index(es) 111 and/or advertisement index(es) 112 can be a structured collection of records or data, for instance, which can be stored in storage module 110. For example, content index(es) 111 and/or advertisement index(es) 112 can be an XML (Extensible Markup Language) database, MySQL, or an Oracle® database. In the same or different embodiments, content index(es) 111 and/or advertisement index(es) 112 can comprise a searchable group of individual data files stored in storage module 110. In some examples, content index(es) 111 and/or advertisement index(es) 112 can be accessed based on user(s) of system 100 operating the user controls (e.g., user control(s) 272 (FIG. 2)) of the interactive advertisement(s) (e.g., interactive advertisement(s) 270 (FIG. 2)) and the content element(s) and/or advertising element(s) may be used by content providing system 101. This information can be used immediately or in subsequent views of a web page or software application (e.g., mobile software application) as described herein. To impact subsequent views of the web page or software application, the information can be stored in storage module 110. Once this information is stored, future creation of content can be influenced by this information.

In the same or different embodiments, generation module 120 can comprise an advertisement module 121, a content module 122, and/or a structure module 123. Advertisement module 121 can be operable to provide (e.g., generate) the interactive advertisement(s) (e.g., interactive advertisement(s) 270 (FIG. 2)) of the content (e.g., content 200 (FIG. 2)) based upon the advertising element(s) stored at advertisement index(es) 112, and content module 122 can be operable to provide (e.g., generate) the primary content (e.g., primary content 260 (FIG. 2)) of the content based upon the content element(s) stored at content index(es) 111. Structure module 123 can be operable to format the content (e.g., content 200 (FIG. 2)) provided to the user(s) of system 100 at user device(s) 193 (e.g., user device 190, user device 191, and/or user device 192) before the content is provided to the user(s) of system 100 at user device(s) 193 (e.g., user device 190, user device 191, and/or user device 192). Accordingly, advertisement module 121 can be configured to retrieve the advertisement element(s) from advertisement index(es) 112. In these or other embodiments, content module 122 can be configured to retrieve the content element(s) from content index(s) 111.

In many examples, advertisement module 121 can generate the interactive advertisement(s) (e.g., interactive advertisement(s) 270 (FIG. 2)) of the content to include the user control(s) (e.g., user control(s) 272 (FIG. 2)). The user(s) of system 100 can use the user control(s) (e.g., user control(s) 272 (FIG. 2)) to alter the interactive advertisement(s) (e.g., interactive advertisement(s) 270 (FIG. 2)) and/or the primary content (e.g., primary content 260 (FIG. 2)) of the content (e.g., content 200 (FIG. 2)) without refreshing, reloading, or resending the content. In various embodiments, the interactive advertisement(s) do not operate as a component of an asynchronous java script and XML application (sometimes referred to by web architects as AJAX). Whether the web page or software application view requires a full refresh or not, does necessarily mean an advertising unit of the web page or software application is operating autonomously from the rest of the web page or software application. In many embodiments, by operating the user control(s) (e.g., user control(s) 272 (FIG. 2)), the user(s) of system 200 can alter (a) an entire interactive advertisement of the interactive advertisement(s) (e.g., interactive advertisement(s) 270 (FIG. 2)) of the content (e.g., content 200 (FIG. 2)), (b) only the user control(s) of the interactive advertisement(s), (c) only the advertising content (e.g., advertising content 271 (FIG. 2)) of the interactive advertisement(s), (d) only the primary content (e.g., primary content 260 (FIG. 2)) of the content; and/or (e) any suitable combination thereof.

In operation, content providing system 101 (e.g., advertisement module 121) can generate interactive advertisement(s) that can be implemented with search results web pages. Notably, system 100 and/or content providing system 101 can provide advantages over conventional online advertisement systems implemented with search results web pages.

For example, when user(s) of a search engine perform a search by entering the keywords “dentist, Chicago,” the search engine can return organic search results for the “dentist, Chicago” keywords. On the same web page, the search results can present paid advertisements that match “dentist, Chicago.” With conventional advertisement systems, to change the content included at the paid advertisements on the web page, a user of the search engine must change the keywords contained in the search query. For example, with conventional advertisement systems, to change the content in the advertisements to orthodontists on or near the Magnificent Mile (i.e., a place in downtown Chicago), the user of the search engine might enter “orthodontist, Magnificent Mile, Chicago” as keywords into the search query box. The result of such search query can be that the organic content as well the content in the paid advertisements change to reflect “orthodontist, Magnificent Mile, Chicago.” If the user of the search engine wanted to change only content of the paid advertisements in the original search query for “dentist, Chicago” to “orthodontist, Magnificent Mile, Chicago,” while keeping the organic search results for the “dentist, Chicago” search query, the user would be unable to do so because there are no user controls that permit this change only to the paid advertisements. However, user(s) of system 100 can change the content in the paid advertisements, such as, for example, to reflect “orthodontist, Magnificent Mile, Chicago” by operating user control(s) at the paid advertisements (e.g., user control(s) indicating “change profession” and/or “change location”) while maintaining the same organic search results for “dentist, Chicago.”.

Indeed, unlike system 100, conventional online advertisement systems do not allow the user to control, select, or manipulate the content so that user(s) can (a) change the advertising content but keep the primary content on the web page the same, (b) change the primary content on the web page containing the advertising content, (c) modify the primary content presented to the user on subsequent web pages on the website, and/or (d) modify the advertising content presented to the user on subsequent pages on the website The interactive advertisement(s) provided by content providing system 101 (e.g., advertisement module 121) can provide all these capabilities, which are not available in conventional online advertisements.

Meanwhile, in many embodiments, structure module 123 can comprise a web page creation module 124 and/or a application software creation module 125. Web page creation module 124 can configure the content provided to the user(s) of system 100 at user device(s) 193 (e.g., user device 190, user device 191, and/or user device 192) for presentation at one or more web pages. Meanwhile, application software creation module 125 can configure the content provided to the user(s) of system 100 at user device(s) 193 (e.g., user device 190, user device 191, and/or user device 192) at a software application (e.g., a mobile software application).

Further, modification module 140 can be configured to alter, based upon one or more requests from the user(s) of system 100, a content and/or a format of the interactive advertisement(s) (e.g., interactive advertisement(s) 270 (FIG. 2)) of the content (e.g., content 200 (FIG. 2)) provided to the user(s) of system 100 at user device(s) 193 (e.g., user device 190, user device 191, and/or user device 192), and/or (b) a content and/or a format of the primary content (e.g., primary content 260 (FIG. 2)) of the content provided to the user(s) of system 100 at user device(s) 193 (e.g., user device 190, user device 191, and/or user device 192). Modification module 140 can be further configured to determine additional elements of content (primary content and/or advertising content) to provide to the user(s) of system 100 at user device(s) 193 (e.g., user device 190, user device 191, and/or user device 192) based upon one or more requests of the user(s) of system 100.

The format of the interactive advertisement(s) and/or primary content can refer to a layout (e.g., location and size) of the interactive advertisement(s) and/or primary content and/or a presentation (e.g., color, font, visual effects, visual differences) of the interactive advertisement(s) and/or primary content, such as, for example, at a web page or software application. Exemplary changes of format can include adding, removing, replacing, sorting, re-ordering, or other layout or presentation changes to the interactive advertisement(s) and/or primary content. Meanwhile, exemplary content changes can comprise (a) adjusting, creating, deleting, and/or replacing types of media (such as video, images, and text) of the interactive advertisement(s) and/or primary content. Further, exemplary content changes to the interactive advertisement(s) can comprise (a) changing the size, shape and interactive nature of the interactive advertisement(s) and/or (b) presenting new or the same user control(s) within the interactive advertisement(s).

In some examples, the user control(s) of the interactive advertisement(s) can respond to and/or be at least one of: (a) a clicking of a computer mouse button of user device(s) 193 (e.g., user device 190, user device 191, and/or user device 192); (b) a pressing of a keyboard button of user device(s) 193 (e.g., user device 190, user device 191, and/or user device 192); (c) a change in position (e.g., a change in altitude, a change in location, a change in speed, a change in angular speed, a change in direction of movement) of user device(s) 193 (e.g., user device 190, user device 191, and/or user device 192); (d) a voice command by the one or more user(s) of system 100 or another sound received at user device(s) 193 (e.g., user device 190, user device 191, and/or user device 192); (e) a hand movement by the user(s) of system 100 received by user device(s) 193 (e.g., user device 190, user device 191, and/or user device 192); (f) an eye movement by the user(s) of system 100 received by user device(s) 193 (e.g., user device 190, user device 191, and/or user device 192); (g) interaction with a touch screen or a trackball (e.g., using a finger or fingers to touch, tap, and swipe in various way as input to the device) by user(s) of system 100 received by user device(s) 193 (e.g., user device 190, user device 191, and/or user device 192); (h) an environmental change (e.g., a change in temperature or a change in barometric pressure) received by user device(s) 193 (e.g., user device 190, user device 191, and/or user device 192); and/or (i) a physical change (e.g., a change in heart rate, a change in body temperature, a change in body chemistry, such as, for example, blood sugar, etc.) of a user of system 100.

In one example, the user control(s) (e.g., user control(s) 272 (FIG. 2)) can cause one or more hyperlinks in the advertising content (e.g., advertising content 271 (FIG. 2)) of the interactive advertisement(s) (e.g., interactive advertisement(s) 270 (FIG. 2)) to change, add, and/or remove hyperlinks depending upon the nature of the user control(s). For example, the original interactive advertisement(s) may have hyperlinks to “buy” items contained in the advertising content. The user can select user control(s) that say “on sale now” that turns off or removes hyperlinks to items in advertising content that are “not on sale” and keeps hyperlinks for items that “are on sale” now.

In other examples, the user control(s) (e.g., user control(s) 272 (FIG. 2)) can comprise a search field that allows the user(s) of system 100 to search for advertisements. For example, the advertising content (e.g., advertising content 271 (FIG. 2)) of an interactive advertisement of the interactive advertisement(s) (e.g., interactive advertisement(s) 270 (FIG. 2)) can be for an automobile of a first model and a user of system 100 can enter a different model of automobile at the search field to change the advertising content to the different model of automobile.

Returning to the hotel example introduced above for purposes of further illustrating the functionality of system 100, the change of hotels for the destination city in an interactive advertisement (e.g., interactive advertisement(s) 270 (FIG. 2)) based on the user of system 100 selecting the other arrival location using the user control(s) (e.g., user control(s) 272) can cause the flight options between the departure and first arrival location in the primary content to change or remain the same, as desirable.

Furthermore, the user control(s) (e.g., user control(s) 272) of the interactive advertisement (e.g., interactive advertisement(s) 270 (FIG. 2)) can be operable by the user of system 100 to cause changes in the content or format of the primary content and/or interactive advertisement(s) on subsequent web pages on the travel website and/or other interactive advertisements of the same web page of the travel website.

For example, after the user selects a flight option between departure and arrival locations and a hotel at the other arrival location (e.g., destination city), the user can be presented with a web page containing a list of “things to do” at the other arrival location which is different from the subsequent default web page content which would normally contain “things to do” at the first arrival location.

In many embodiments, content providing system 101 can recognize sensors of user device(s) 193 (e.g., user device 190, user device 191, and/or user device 192) that can be used as additional user control(s) of the interactive advertisement(s) (e.g., interactive advertisement(s) 270 (FIG. 2) of the content (content 200 (FIG. 2)). For example, electronic sensors built into user device(s) 193 (e.g., user device 190, user device 191, and/or user device 192) can act as user control(s). These electronic sensors can determine, for example, a physical location of user device(s) 193 (e.g., user device 190, user device 191, and/or user device 192) using a location service, positional direction of user device(s) 193 (e.g., user device 190, user device 191, and/or user device 192), altitude, pitch, and/or angle of user device(s) 193 (e.g., user device 190, user device 191, and/or user device 192), voice commands input to user device(s) 193 (e.g., user device 190, user device 191, and/or user device 192), and/or video or audio input. Further, the electronic sensors can determine a physical condition of the user(s) of user device(s) 193 (e.g., user device 190, user device 191, and/or user device 192), such as, for example, by detecting perspiration, heart rate, blood sugar, etc. In some examples, user device(s) 193 (e.g., user device 190, user device 191, and/or user device 192) can comprise electronic devices (e.g., mobile devices, tablet devices, desktop computers, glasses, televisions, netbooks, kiosk devices, laptop computers, or watches) which can be used by user(s) of system 100 to access the software applications or web pages containing content provided to the user(s) of system 100 at user device(s) 193 (e.g., user device 190, user device 191, and/or user device 192).

For example, a user sitting on the 42nd floor of the Empire State Building in

New York City looking at a web page through their mobile device can see an interactive advertisement (e.g., interactive advertisement(s) 270) on a web page containing lawyers located only on the 42nd floor in the Empire State Building based on the altitude sensor in the mobile device and the set radius of the search query for “lawyers.”

In some examples, the user control(s) (e.g., user controls 272) can be a free format text box. In one example, the free format text box can be a search box.

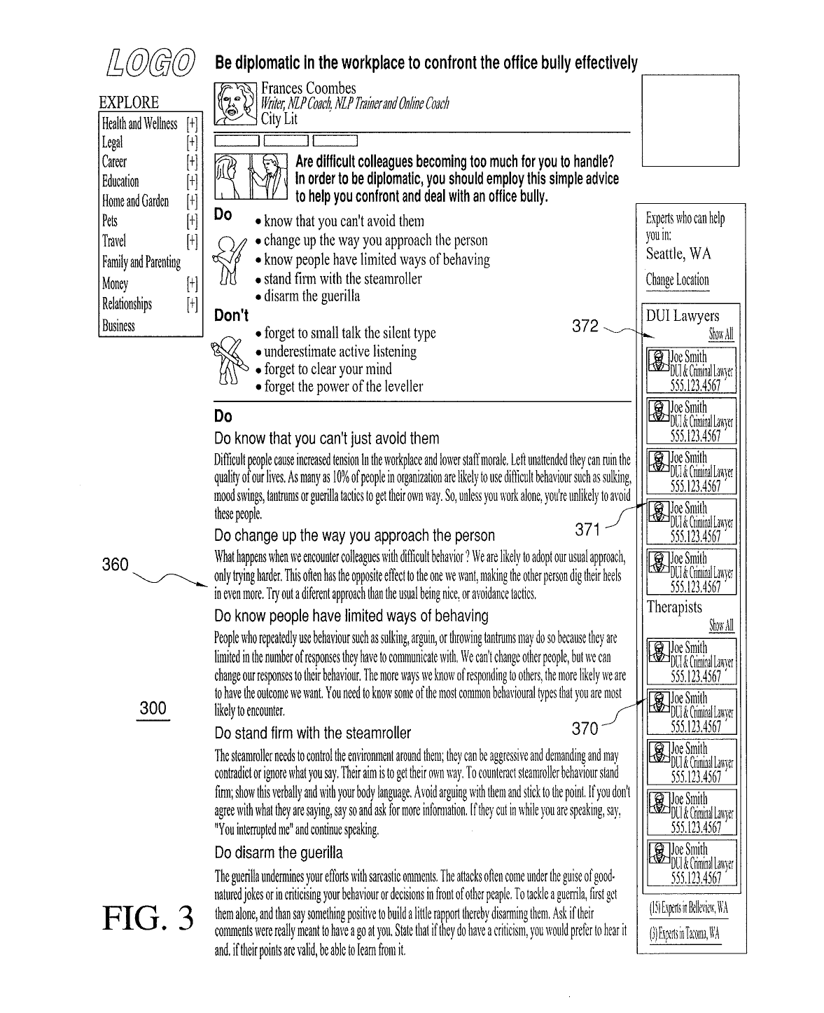

Turning ahead in the drawings, FIG. 3 illustrates exemplary content 300, according to an embodiment. Content 300 can be similar or identical to the content described above with respect to system 100 (FIG. 1) and/or to content 200 (FIG. 2). Accordingly, content 300 can comprise primary content 360 and interactive advertisement 370, and interactive advertisement 370 can comprise advertising content 371 and one or more user controls 372. Meanwhile, primary content 360 can be similar or identical to the primary content described above with respect to system 100 (FIG. 1) and/or to primary content 260 (FIG. 2); interactive advertisement 370 can be similar or identical to any interactive advertisement of the interactive advertisement(s) described above with respect to system 100 (FIG. 1) and/or to interactive advertisement(s) 271 (FIG. 2); advertising content 371 can be similar or identical to the advertising content described above with respect to system 100 (FIG. 1) and/or to advertising content 271 (FIG. 2); and/or user control(s) 372 can be similar or identical to the user control(s) described above with respect to system 100 (FIG. 1) and/or to user control(s) 272 (FIG. 2).

In the example of FIG. 3, advertising content 371 comprises a list of experts presented in interactive advertisement 370 on the right of primary content 360 of content 300 of a web page. The experts are professional or service providers (e.g. lawyers, doctors, dentists, real estate agents) for a particular geographical location who have paid a fee to be present in interactive advertisement 370. The professionals are grouped by profession and ordered by their relevance to primary content 360 or based on current or historical data derived from the actions of a user of the web page or web page(s) viewed before coming to the web page. The professionals listed and professions presented at interactive advertisement 370 can be changed by the user by operation of user controls 372 to change a location of the professionals listed and professions presented which will result in a new group of professionals and new professions based on who is advertising for that location and content. The user can have the ability to initiate a message to a professional of the professionals listed directly within interactive advertisement 370.

Additionally, assuming content providing system 101 (FIG. 1) is providing content 300, content providing system 101 can permit a user of the web page to operate user control(s) 372 to: (a) hide/close specific professionals or professions by selecting a “hide/close” control of user control(s) 372 within interactive advertisement 370; (b) switch to a video view of the professionals that will play their promotional videos at interactive advertisement 370 instead of just viewing default profile images at interactive advertisement 370; (c) select a “map control” to display a map of the professionals' office locations on a map inside an expanded version of interactive advertisement 370 and then be able to select a “driving directions” user control providing turn-by-turn driving directions from their present or a selected location to a professional's office; (d) select a “multi-office map control” to display a map containing all of the professional's office locations on a single map at interactive advertisement 370; (e) select a “products and services control” that will present promotion information such as book, products, testimonials, or other services offered; (f) select a “speak with expert control” that will enable the user to two-way interact directly with an expert at interactive advertisement 370 via video or audio talk or text message; (g) select a “seek a bid control” allowing the user to enter an issue into a text field at interactive advertisement 371 and be presented professionals with an associated dollar bid for each professional to help the user solve the issue; (h) select a “save the professional control” so that for the rest of a session for the user on a cunent website having the web page, the professional presented at interactive advertisement 370 never changes as the user moves from one web page to another page, and/or the professionals presented at interactive advertisement 370 always include the professional saved as well as presenting new additional professionals as the user moves from one web page to another (in the same website and on external websites and future online sessions); (i) switch or open an interactive view that allows the user and the professional to communicate directly through illustration (e.g., online whiteboard) or interactive software or cloud application (e.g. Google® docs), or expose new user control(s) that allow the user to upload or enter content (e.g., video, text, documents, images) for one or more of the professionals; and/or (j) allow the user to “save” any or all of the advertising content contained at interactive advertisement 371 that pertains to the professional(s)—such as a name of the professional, a professional's profile, contact information for the professional, address information for the professional, a picture of the professional, etc.

Moreover, in these or other embodiments, the user can operate user control(s) 372 at interactive advertisement 370 to change advertising content 371 of interactive advertisement 370 without changing primary content 360. However, in still other embodiments, the user can operate user control(s) 372 at interactive advertisement 370 to change primary content 360 and/or a format of primary content 360 presented at the web page.

Meanwhile, in response to the user of the web page using user controls 372, modification module 140 (FIG. 1) can change user control(s) 372 at interactive advertisement 370 which may or may not also cause modification module 140 to change advertising content 371, a format of advertising content 371, primary content 360, and/or a format of primary content 360. Interactive advertisement 371 can act autonomously from the webpage (or in other examples, a software application), but not necessarily focused on whether the web page (or software application) requests a complete refresh.

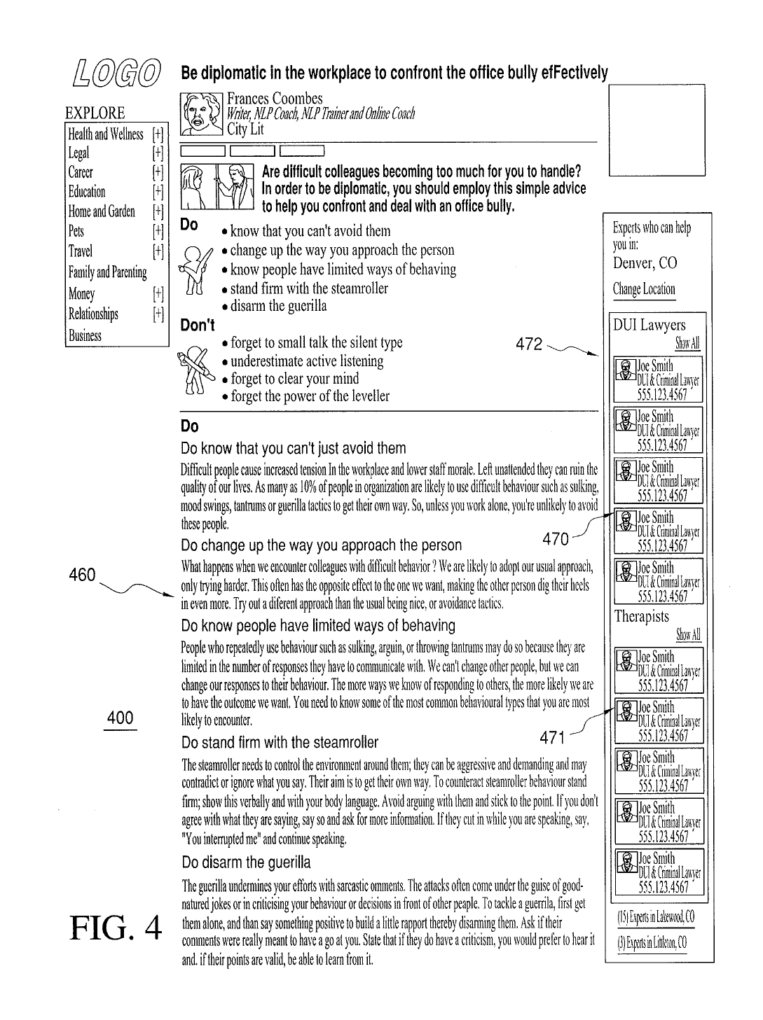

Turning ahead in the drawings, FIG. 4 illustrates exemplary content 400, according to an embodiment. Content 400 can be provided at a web page or software application. Content 400 can be similar or identical to the content described above with respect to system 100 (FIG. 1), content 200 (FIG. 2), and/or content 300 (FIG. 3). Accordingly, content 400 can comprise primary content 460 and interactive advertisement 470, and interactive advertisement 470 can comprise advertising content 471 and one or more user controls 472. Meanwhile, primary content 460 can be similar or identical to the primary content described above with respect to system 100 (FIG. 1), to primary content 260 (FIG. 2), and/or to primary content 360 (FIG. 3); interactive advertisement 470 can be similar or identical to any interactive advertisement of the interactive advertisement(s) described above with respect to system 100 (FIG. 1) or of interactive advertisement(s) 271 (FIG. 2) and/or to interactive advertisement 371 (FIG. 3); advertising content 371 can be similar or identical to the advertising content described above with respect to system 100 (FIG. 1), to advertising content 271 (FIG. 2), and/or to advertising content 371 (FIG. 3); and/or user control(s) 372 can be similar or identical to the user control(s) described above with respect to system 100 (FIG. 1), to user control(s) 272 (FIG. 2, and/or to user control(s) 372 (FIG. 3)).

Assuming content providing system 101 (FIG. 1) is providing content 400, modification module 140 (FIG. 1) can change user control(s) 472 and advertising content 471. In this example, a user has changed his location in interactive advertisement 470 from Denver to Seattle. In this example, Seattle will be retained as the location for interactive advertisement 470 until changed again by the user. With the location set by the user as Seattle, only Seattle professionals and professions applicable to primary content 460 will be presented at interactive advertisement 470 on all subsequent web pages visited by the user.

Some embodiments include a method of providing (e.g., manufacturing) a system. The system can be similar or identical to system 100 (FIG. 1). Notably, the method can comprise providing a content providing system. The content providing system can be similar or identical to content providing system 101 (FIG. 1).

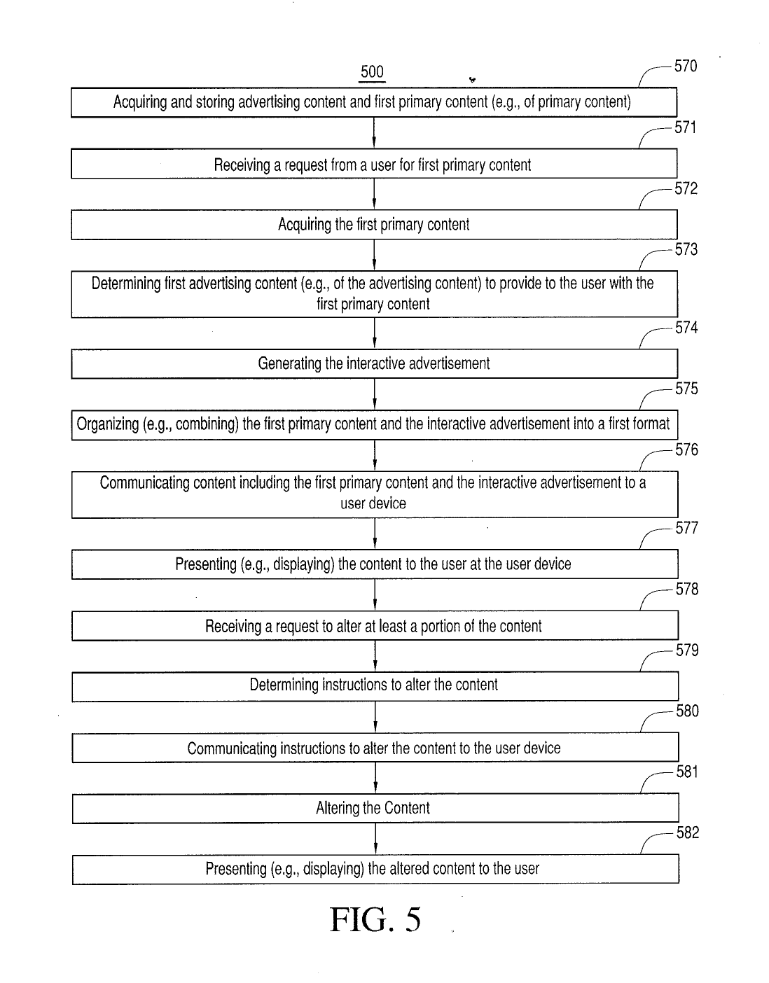

Turning now to the next drawing, FIG. 5 illustrates a flow chart for an embodiment of a method 500 of providing content to a user. In some embodiments, method 500 can be considered a method of providing advertisements on a web page or providing advertisements in a software application. In various embodiments, method 500 can also be considered a method of distributing content or advertisements. Method 500 is merely exemplary and is not limited to the embodiments presented herein. Method 500 can be employed in many different embodiments or examples not specifically depicted or described herein. In some embodiments, the activities, the procedures, and/or the processes of method 500 can be performed in the order presented. In other embodiments, the activities, the procedures, and/or the processes of method 500 can be performed in any other suitable order. In still other embodiments, one or more of the activities, the procedures, and/or the processes in method 500 can be combined or skipped. Generally, method 500 is described in the context of system 100 (FIG. 1), which can be implemented to perform part or all of method 500. Meanwhile, one or more of the activities of method 500 can comprise computer instructions configured to be operated at a processing module of a computer system, and the computer system can be similar or identical to computer system 600 (FIG. 6).

In some embodiments, method 500 can comprise an activity 570 of acquiring and storing advertising content and first primary content (e.g., of primary content). In some examples, advertisement module 121 (FIG. 1) can receive advertising content from one or more advertisers. The advertising content can be stored in advertisement index(es) 112 (FIG. 1). Content module 122 (FIG. 1) can receive primary content from one or more content providers. In the same or different embodiment, an owner or operator of content providing system 101 (FIG. 1) can create primary content. The primary content can be stored in content index(es) 111 (FIG. 1). In many embodiments, advertising content can be regularly (e.g., hourly, daily, weekly, or monthly) updated or changed. The advertising content can be similar or identical to the advertising content described above with respect to system 100 (FIG. 1), to advertising content 271 (FIG. 2), to advertising content 371 (FIG. 3), and/or to advertising content 471 (FIG. 4). Further, the primary content can be similar or identical to the primary content described above with respect to system 100 (FIG. 1), to primary content 260 (FIG. 2), to primary content 360 (FIG. 3), and/or to primary content 460 (FIG. 4).

In some embodiments, method 500 can comprise an activity 571 of receiving a request from a user for first primary content. The user can request the first primary content using a user device (e.g., user device 190, user device 191, and/or user device 192) of user device(s) 193 (FIG. 1). The user device of user device(s) 193 can communicate the request to communications module 130 (FIG. 1) via the Internet or another communications network. The request can be for a request for a web page with first primary content or a request for the first primary content from a software application (e.g., a mobile software application) running on the user device of user device(s) 193.

In some embodiments, method 500 can comprise an activity 572 of acquiring the first primary content. In some examples, content module 122 (FIG. 1) can retrieve the first primary content from content index(es) 111 (FIG. 1). Additionally or alternatively, content module 122 (FIG. 1) can acquire the first primary content from one or more primary content providers (not shown). In various examples, content module 122 (FIG. 1) can receive primary content (including, but not limited to, the first primary content) from primary content providers and store the primary content in content index(es) 111. In many embodiments, primary content is regularly (e.g., hourly, daily, weekly, or monthly) updated or changed.

In some embodiments, method 500 can comprise an activity 573 of determining first advertising content (e.g., of the advertising content) to provide to the user with the first primary content. In some examples, advertisement module 121 (FIG. 1) can determine first advertising content to display to the user with the first primary content. Advertisement module 121 (FIG. 1) can use many different factors to determine what first advertising content to display. In various examples, advertisement module 121 (FIG. 1) can use information about the user requesting the first primary content to at least partially determine the first advertising content to provide to the user.

In some embodiments, advertisement module 121 (FIG. 1) can determine whether the first advertising content is relevant to the first primary content. In various embodiments, advertisement module 121 (FIG. 1) can determine whether the first advertising content is relevant to the first primary content based on rules and/or algorithms contained within an interactive advertisement associated with one or more user control(s) of the interactive advertisement, external rules or algorithms inherent and specific for that interactive advertisement, or based on information known about the user derived from cookies, browser, online history, demographics, behavioral characteristics, or information provided by the advertiser or advertisers. The interactive advertisement can be similar or identical to any interactive advertisement of the interactive advertisement(s) described above with respect to system 100 (FIG. 1) or of interactive advertisement(s) 270 (FIG. 1), to interactive advertisement 370 (FIG. 3), and/or to interactive advertisement 470 (FIG. 4). Further, the user control(s) can be similar or identical to the user control(s) described above with respect to system 100 (FIG. 1), to user control(s) 272 (FIG. 2), to user control(s) 372 (FIG. 3), and/or to user control(s) 472 (FIG. 4).

For example, if the first primary content is related to cats, advertisement module 121 (FIG. 1) can determine that advertisements related to cat food are more relevant to the first primary content than advertisements for automobile parts, and the cat food advertisements can be paired with the primary content related to cats. In the same or different examples, advertisement module 121 (FIG. 1) can determine which advertiser will potentially pay the owner or operator of content providing system 101 (FIG. 1) the most money to display the advertisement and display that advertising content.

In some embodiments, advertisement module 121 (FIG. 1) can retrieve first the advertising content from advertisement index(es) 112 (FIG. 1). In other examples, advertisement module 121 can obtain the advertising content from a third party advertising service. In various examples, advertisement module 121 can provide information about the requestor and/or the first primary content to the third party advertising service when requesting advertising content from the third party advertisement service.

In some embodiments, method 500 can comprise an activity 574 of generating the interactive advertisement. In some examples, advertisement module 121 (FIG. 1) can construct the interactive advertisement. The interactive advertisements can include the first advertising content and the user control(s). In some examples, advertisement module 121 can construct the interactive advertisements by combining the first advertising content with one or more control mechanism elements (i.e., computer software elements (e.g., JAVA script)) as the user control(s). The interactive advertisement can be provided at a web page or software application. After the interactive advertisement is generated, advertisement module 121 can communicate the interactive advertisement to structure module 123 (FIG. 1).

The user control(s) can be defined and created so a user can interact with the first advertising content within the interactive advertisement to change its content or modify its format. To accomplish the change, the first advertising content can be created so it changes in conjunction with and/or in reaction to operation of the user control(s). For example, if an exemplary interactive advertisement is defined and created to display available cars for rent as the first advertising content so that a user can use a filter of the user control(s) to only show a class of car (e.g. compact, SUV, truck), the first advertising content of the interactive advertisement can be created to support this interactive action. In this example, advertisement index(es) of advertisement index(es) 112 (FIG. 1) containing advertising content for this advertisement type can contain car class and a filter user control for this advertisement type that can pull the available filterable values from the car classes, making them available to the user to select, and the advertising content can be modified to only show the selected car classes in at the interactive advertisement.

In some embodiments, method 500 can comprise an activity 575 of organizing (e.g., combining) the first primary content and the interactive advertisement into a first format. In many embodiments, structure module 123 (FIG. 1) can create provided content to communicate to the user by arranging the first primary content and the interactive advertisement into the first format. The first format can depend on the user device of user device(s) 193 (FIG. 1) and/or application software (e.g., mobile application software) that the user is using to receive the first primary content. For example, if the user is going to display the primary content in a web browser, web page creation module 124 (FIG. 1) of structure module 123 (FIG. 1) can format the first primary content and the interactive advertisement into a web page format. In another example, if the user is going to display the content on a software application (e.g., a mobile software application), application software creation module 125 (FIG. 1) of structure module 123 (FIG. 1) can format the first primary content and the interactive advertisement (including the user controls) into a format operable by the user at the software application. In some examples, user controls might not be operable on the user device so the interactive advertisement (including the user controls) can be formatted into a format operable by the software application on another user device of user device(s) 193 on which the user control(s) are operable.

In many examples, the interactive advertisement can include instructions (e.g., computer software code) that allow the content or the format of the interactive advertisement to be altered without refreshing, reloading, or resending all of the provided content. For example, web page creation module 124 can format the web page to include instructions to alter the content or the format of the interactive advertisement (or the content or format of the first primary content) without refreshing, reloading, or resending the web page. Similarly, application software creation module 125 can include instructions to allow altering the content or the format of the interactive advertisements (or the content or format of the first primary content) without refreshing, reloading, or resending all the provided content from content providing system 101 (FIG. 1).

In some embodiments, method 500 can comprise an activity 576 of communicating the content including the first primary content and the interactive advertisement to a user device (e.g., the user device requesting the primary content). In some examples, communications module 130 (FIG. 1) can communicate the content so that the first primary content and the interactive advertisement are in the first format. The content can be similar or identical to the content described above with respect to system 100 (FIG. 1), to content 200 (FIG. 2), to content 300 (FIG. 3), and/or to content 400 (FIG. 4).

In some embodiments, method 500 can comprise an activity 577 of presenting (e.g., displaying) the content to the user at the user device. In some examples, communications module 130 (FIG. 1) can facilitate presenting (e.g., displaying) the content to the user at the user device. In other embodiments, activity 577 can be omitted.

In some embodiments, method 500 can comprise an activity 578 of receiving a request to alter at least a portion of the content (e.g., by the user via the user control(s)). In some examples, activity 578 can comprise receiving a request to alter (i.e., manipulate or change) at least one of the first primary content, the interactive advertisement, or the first format. Communications module 130 (FIG. 1) can receive the request from the user device (e.g., user device 190 (FIG. 1), user device 191 (FIG. 1), or user device 192 (FIG. 1)) of user device(s) 193 (FIG. 1)).

In some embodiments, method 500 can comprise an activity 579 of determining instructions to alter the content. In various embodiments, modification module 140 (FIG. 1) can use the request to determine instructions to alter at least one of the first primary content, the interactive advertisement, or the first format.

In some examples, modification module 140 can perform a query of advertising content index(es) 112 (FIG. 1) or content index(es) 111 (FIG. 1) to determine revised advertising content for the interactive advertisement or revised primary content for first primary content, respectively. In the same or different example, modification module 140 (FIG. 1) can determine one or more second user controls for at least one of interactive advertisements. That is, modification module 140 (FIG. 1) can change the user control(s) in the interactive advertisements in response to the user interacting with the user control.

Furthermore, in response to receiving the request for the user to alter the interactive advertisements, modification module 140 (FIG. 1) can determine instructions to reformat the content of the interactive advertisement. In the same or different examples, the information provided by the user via the user control(s) can be stored at storage module 110 (FIG. 1) for future use, for example, when serving another web page to the same user in the future.

In some embodiments, method 500 can comprise an activity 580 of communicating instructions to alter the content to the user device. In some examples, the instructions instruct the user device to alter the at least one of the first primary content, the interactive advertisement, or the first format without reloading, refreshing, or resending all of the content (e.g., at the web page). In some examples, communications module 130 can communicate the instructions to the user device via the Internet or another communication network.

In some embodiments, method 500 can comprise an activity 581 of altering the content. In some examples, the user device can alter a content or a format of the interactive advertisement based on the request of the user without reloading, refreshing, or resending all of the content (e.g., at the web page). In some examples, the altered advertising content can be inserted at the interactive advertisement or the altered primary content can be inserted at the first primary content without reloading, refreshing, or resending all of the content. In the same or different examples, altering the content can include reformatting the content of the interactive advertisement and/or replacing the user control(s) with the one or more second user controls without reloading, refreshing, or resending all the content (e.g., at the web page).

Next, method 500 of FIG. 5 includes an activity 582 of presenting (e.g., displaying) the altered content to the user. In some examples, the altered content can be presented (e.g., displayed) to the user at the user device. In these or other examples, communications module 130 (FIG. 1) can facilitate presenting (e.g., displaying) the altered content to the user at the user device. After activity 582, method 500 can be complete. In many examples, method 500 can be repeated for new primary content and/or additional web pages or software applications (e.g., mobile software applications). In some embodiments, activities 570-582 can be performed in the above order. However, in many embodiments, one or more of activities 570-582 can be performed approximately simultaneously and/or in a different order. In other embodiments, one or more of activities 570-582 can be omitted.

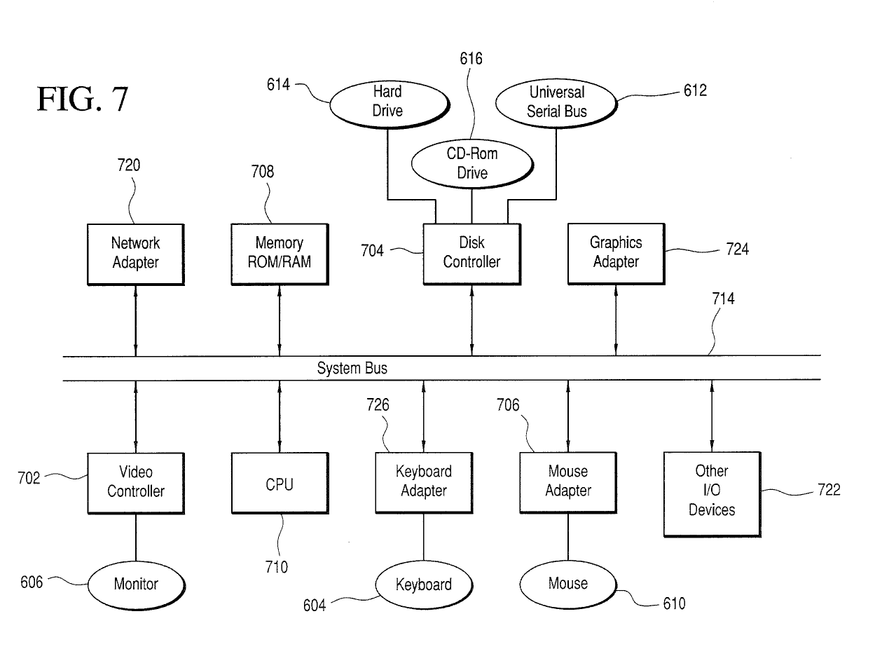

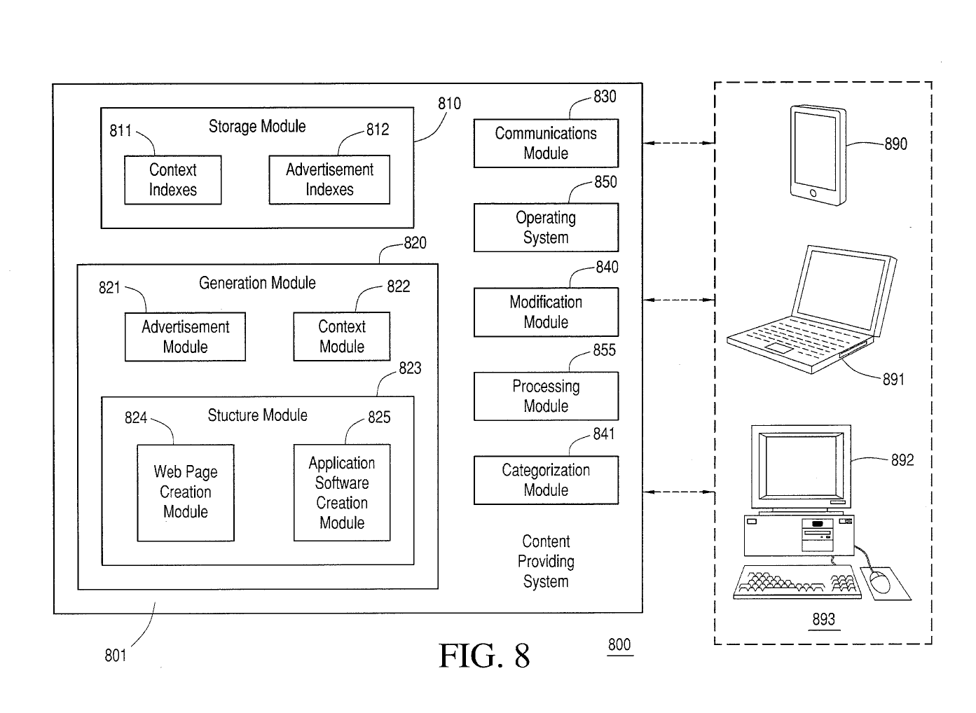

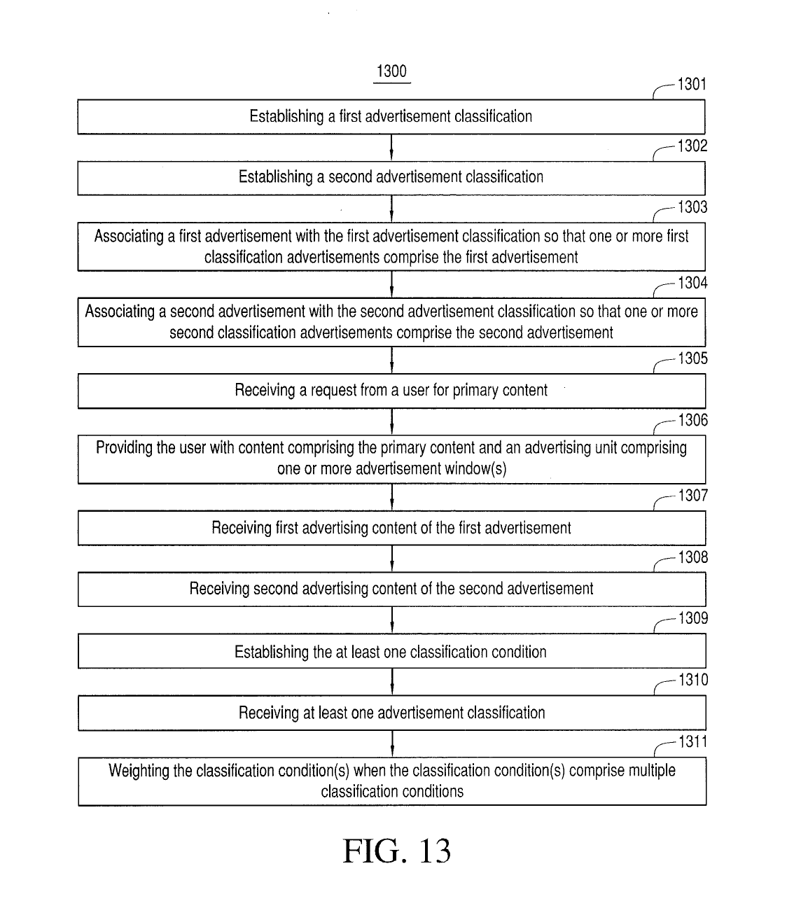

Turning to the next drawings, FIG. 6 illustrates a computer 600 that is suitable for implementing an embodiment of at least a portion of system 100 (FIG. 1) (e.g., content providing system 101 (FIG. 1) and/or user device(s) 193 (FIG. 1), such as, for example, user device 190 (FIG. 1), user device 191 (FIG. 1), and/or user device 192 (FIG. 1)), method 500 (FIG. 5), at least a portion of system 800 (FIG. 8) (e.g., content providing system 801 (FIG. 8) and/or user device(s) 893 (FIG. 8), such as, for example, user device 890 (FIG. 8), user device 891 (FIG. 8), and/or user device 892 (FIG. 8)), and/or method 1300 (FIG. 13). Computer 600 includes a chassis 602 containing one or more circuit boards (not shown), a USB (universal serial bus) port 612, a Compact Disc Read-Only Memory (CD-ROM) and/or Digital Video Disc (DVD) drive 616, and a hard drive 614. A representative block diagram of the elements included on the circuit boards inside chassis 602 is shown in FIG. 7. A central processing unit (CPU) 710 in FIG. 7 is coupled to a system bus 714 in FIG. 7. In various embodiments, the architecture of CPU 710 can be compliant with any of a variety of commercially distributed architecture families.

System bus 714 also is coupled to memory 708 that includes both read only memory (ROM) and random access memory (RAM). Non-volatile portions of memory 708 or the ROM can be encoded with a boot code sequence suitable for restoring computer 600 (FIG. 6) to a functional state after a system reset. In addition, memory 708 can include microcode such as a Basic Input-Output System (BIOS). In some examples, storage module 110 (FIG. 1) can include memory 1708, USB (universal serial bus) drive 1612, hard drive 1614, and/or CD-ROM or DVD drive 1616.

In the depicted embodiment of FIG. 7, various I/O devices such as a disk controller 704, a graphics adapter 724, a video controller 702, a keyboard adapter 726, a mouse adapter 706, a network adapter 720, and other I/O devices 722 can be coupled to system bus 714. Keyboard adapter 726 and mouse adapter 706 are coupled to a keyboard 604 (FIGS. 6 and 7) and a mouse 610 (FIGS. 6 and 7), respectively, of computer 600 (FIG. 6). While graphics adapter 724 and video controller 702 are indicated as distinct units in FIG. 7, video controller 702 can be integrated into graphics adapter 724, or vice versa in other embodiments. Video controller 702 is suitable for refreshing a monitor 606 (FIGS. 6 and 7) to display images on a screen 608 (FIG. 6) of computer 600 (F1G. 6). Disk controller 704 can control hard drive 614 (FIGS. 6 and 7), USB drive 612 (FIGS. 6 and 7), and CD-ROM or DVD drive 616 (FIGS. 6 and 7). In other embodiments, distinct units can be used to control each of these devices separately.

In some embodiments, network adapter 720 is part of a WNIC (wireless network interface controller) card (not shown) plugged or coupled to an expansion port (not shown) in computer 600 (FIG. 6). In other embodiments, the WNIC card can be a wireless network card built into computer 600 (FIG. 6). A wireless network adapter can be built into computer 600 (FIG. 6) by having wireless Ethernet capabilities integrated into the motherboard chipset (not shown), or implemented via a dedicated wireless Ethernet chip (not shown), connected through the PCI (peripheral component interconnector) or a PCI express bus. In other embodiments, network adapter 720 can be a wired network adapter.

Although many other components of computer 600 (FIG. 6) are not shown, such components and their interconnection are well known to those of ordinary skill in the art. Accordingly, further details concerning the construction and composition of computer 600 (FIG. 6) and the circuit boards inside chassis 602 (FIG. 6) need not be discussed herein.

When computer 600 in FIG. 6 is running, program instructions stored on stored on a USB drive in USB port 612, on a CD-ROM or DVD in CD-ROM and/or DVD drive 616, on hard drive 614, or in memory 708 (FIG. 7) are executed by CPU 710 (FIG. 7). A portion of the program instructions, stored on these devices, can be suitable for carrying out method 500 (FIG. 5) as described previously above and/or for carrying out method 1300 (FIG. 13) as described below.

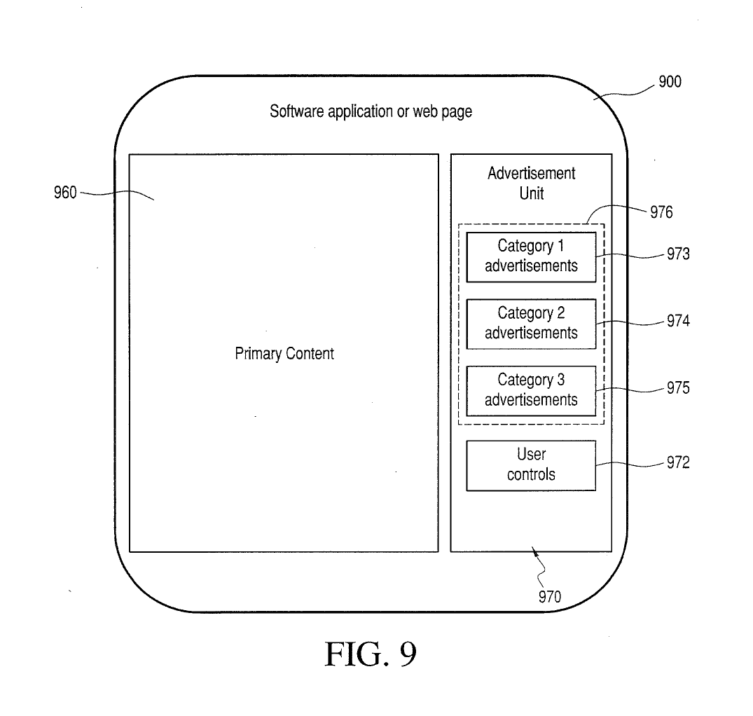

Turning ahead again in the drawings, FIG. 8 illustrates a representative block diagram of a system 800 for providing content (e.g., providing advertising), according to an embodiment. In these or other embodiments, the content can be provided at one or more web pages, at a software application (e.g., a mobile software application), at a television, at a radio broadcast, and/or any other suitable content providing medium. In some embodiments, system 800 can be implemented to provide the content to one or more users of system 800 at one or more user devices 893 (e.g., a user device 890, a user device 891, and/or a user device 892), as discussed below. System 800 is merely exemplary and is not limited to the embodiments presented herein. System 800 can be employed in many different embodiments or examples not specifically depicted or described herein. Meanwhile, FIG. 9 illustrates a representative block diagram of exemplary content 900 of a web page or a software application (e.g., mobile software application) created using system 900. Accordingly, the content provided by system 800 (FIG. 8) can be similar or identical to content 900.

Referring to FIG. 8, in many embodiments, system 800 can be similar to system 100 (FIG. 1). For example, system 800 can comprise a content providing system 801. Content providing system 801 can provide the content to the user(s) of system 800 at user device(s) 893 (e.g., user device 890, user device 891, and/or user device 892) of system 800 and/or the users of system 800. In these or other embodiments, content providing system 801 can be similar to content providing system 101 (FIG. 1); and/or user device(s) 893 can be similar or identical to user device(s) 193 (FIG. 1).

Accordingly, in many embodiments, content providing system 801 can comprise a computer system. In these or other embodiments, one or more of user device(s) 893 (e.g., user device 890, user device 891, and/or user device 892) each can comprise a computer system. The computer system of content providing system 801 and/or user device(s) 893 (e.g., user device 890, user device 891, and/or user device 892) can be similar or identical to computer system 600 (FIG. 6). In some embodiments, system 800 can comprise user device(s) 893 (e.g., user device 890, user device 891, and/or user device 892).

Further, in these or other embodiments, content providing system 801 can comprise a processing module 855, a storage module 810, a generation module 820, a communications module 830, a modification module 840, and/or an operating system 850. In many embodiments, processing module 855 can be similar or identical to processing module 155 (FIG. 1); generation module 820 can be similar to general module 120 (FIG. 1); communications module 830 can be similar or identical to communications module 130 (FIG. 1); modification module 840 can be similar or identical to modification module 140 (FIG. 1); and/or operating system 850 can be similar or identical operating system 150 (FIG. 1).

Further still, generation module 820 can comprise an advertisement module 821, a content module 822, a structure module 823, a web page creation module 824, and/or a software application creation module 825. Meanwhile, storage module 810 can comprise one or more content indexes 811 and/or one or more advertisement indexes 812. Advertisement module 821 can be similar to advertisement module 121 (FIG. 1); content module 822 can be similar to content module 122 (FIG. 1); structure module 823 can be similar to structure module 123 (FIG. 1); web page creation module 824 can be similar or identical to web page creation module 124 (FIG. 1); software application creation module 825 can be similar or identical to application software creation module 125 (FIG. 1); content index(es) 811 can be similar or identical to advertisement index(es) 111 (FIG. 1); and/or advertisement index(es) 812 can be similar or identical to advertisement index(es) 112 (FIG. 1).

Notably, system 800 can perform similar or identical functionality to system 100 (FIG. 1). For example, as discussed in greater detail below, generation module 820 can determine (e.g., generate) content (e.g., content 900 (FIG. 9)) to provide to the user(s) of system 800 at user device(s) 893 (e.g., user device 890, user device 891, and/or user device 892), and/or modification module 840 can alter content (e.g., content 900 (FIG. 9)) provided to the user(s) of system 800 at user device(s) 893 (e.g., user device 890, user device 891, and/or user device 892). Meanwhile, communications module 830 can provide the content determined by generation module 820 and/or altered by modification module 840 to the user(s) of system 800 at user device(s) 893 (e.g., user device 890, user device 891, and/or user device 892) for content providing system 801.

In these or other embodiments, system 800 can also perform additional functionality as discussed herein. Accordingly, in many embodiments, content providing system 801 can comprise a categorization module 841. In many embodiments, at least part of categorization module 841 can be implemented as computer software. Accordingly, in these or other embodiments, at least part of categorization module 841 can be configured to run at processing module 890 and/or to be stored at storage module 810. In some embodiments, at least part of categorization module 841 can also be configured to be stored at the volatile computer memory storage devices of content providing system 801 as may be necessary to performed the desired functions of system 800 and/or content providing system 801.

Likewise, although categorization module 841 is described herein generally as being located at part of a single computer or server, in many embodiments, parts of categorization module 841 may be spread between and/or possibly overlap at multiple servers when the computer system of content providing system 801 comprises a cluster of collection of servers. For example, the computer system of content providing system 801 can comprise a first server comprising a first portion of categorization module 841. Meanwhile, one or more second servers can comprise a second, possibly overlapping, portion of categorization module 841.

Turning ahead briefly to FIG. 9, content 900 can be similar to the content described above with respect to system 100 (FIG. 1), to content 200 (FIG. 2), to content 300 (FIG. 3), and/or to content 400 (FIG. 2). Accordingly, content 900 can comprise primary content 960, which can be similar or identical to the primary content described above with respect to system 100 (FIG. 1), to primary content 260 (FIG. 2), to primary content 360 (FIG. 3), and/or to primary content 460 (FIG. 4). Meanwhile, content 900 can also comprise at least one advertising unit 970. Advertising unit(s) 970 can be similar or identical to the advertising unit(s) described above with respect to system 100 (FIG. 1).

Each advertising unit of advertising unit(s) 970 can comprise one or more advertisement windows 976 (e.g., advertisement window 973, advertisement window 974, and/or advertisement window 975) In some embodiments, one or more advertising units of advertising unit(s) 970 can also comprise one or more user controls 972. User control(s) 972 can be similar to the user control(s) described above with respect to system 100 (FIG. 1), to user control(s) 272 (FIG. 2), to user control(s) 372 (FIG. 3), and/or to user control(s) 472 (FIG. 4). User control(s) 972 can be associated with the advertising unit of advertising unit(s) 970 as a whole rather than with a particular interactive advertisement. In other embodiments, user control(s) 972 can be omitted.

Meanwhile, advertisement window(s) 976 (e.g., advertisement window 973, advertisement window 974, and/or advertisement window 975) each can correspond to a different advertisement classification and can be configured to present (e.g., display) one or more advertisements associated with the advertisement classification with which that advertisement window element corresponds. In these or other embodiments, the advertisements associated with the various advertisement classifications can comprise conventional advertisements (e.g., conventional online advertisements) and/or the interactive advertisement(s) described above with respect to system 100 (FIG. 1). Advertisement classification is discussed in greater detail below with respect to categorization module 841 (FIG. 8).

Turning now back to FIG. 8, as discussed in greater detail below, in many embodiments, categorization module 841 can (i) establish multiple advertisement classifications, (ii) associate advertisements with the multiple advertisement classifications, and (iii) determine, based on at least one classification condition being satisfied, what advertisement window(s) are provided at the one or more advertising unit(s), respectively, of the content (e.g., content 900 (FIG. 9)) that generation module 820 determines (e.g., generates) to provide to the user(s) of system 800 at user device(s) 893 (e.g., user device 890, user device 891, and/or user device 892). In these or other embodiments, the advertisement window(s) can be similar or identical to advertisement window(s) 976 (e.g., advertisement window 973, advertisement window 974, and/or advertisement window 975).

In many embodiments, categorization module 841 can communicate with advertisement module 821 and/or advertisement index(es) 812 to associate advertisements with the multiple advertisement classifications. In these or other embodiments, advertisement module 821 can be operable to provide (e.g., generate) advertisement(s) (e.g., conventional advertisement(s) and/or interactive advertisement(s)) for the advertising unit(s) of the content (e.g., content 900 (FIG. 9)) to be provided to the user(s) of system 800 at user device(s) 893 (e.g., user device 890, user device 891, and/or user device 892) using the advertising element(s) stored at advertisement index 812. Meanwhile, categorization module 841 can associate the advertisement(s) provided by advertisement module 821 with applicable advertisement classifications directly, or indirectly, by associating the advertising element(s) with the applicable advertisement classifications. Categorization module 841 can associate the advertisement(s) and/or advertising element(s) with the applicable advertisement classifications using any suitable electronic association techniques, such as, for example, using metadata tagging.

In these or other embodiments, the advertising content of the advertisement(s) provided by advertisement module 821 can relate to one or more advertisers. Further, each advertisement of the advertisement(s) and/or each advertising element of the advertising element(s) can be associated with one or more of the advertisement classification(s), as explained in greater detail below.

The advertisement classification(s) can comprise any common theme with which the advertisement(s) and/or advertising element(s) can be associated, and the classification condition(s) can comprise any suitable predetermined occurrence(s) for which it may be desirable to provide advertisement(s) associated with a particular advertisement classification to the user(s) of system 800. In other words, the classification condition(s) can comprise one or more rules that govern what advertisement window(s) are provided at the one or more advertising unit(s), respectively, of the content (e.g., content 900 (FIG. 9)) that generation module 820 determines (e.g., generates) to provide to the user(s) of system 800 at user device(s) 893 (e.g., user device 890, user device 891, and/or user device 892), with each advertisement window being configured to present one or more advertisement(s) associated with an advertisement classification that is associated with that advertisement window. In these or other embodiments, the classification condition(s) can comprise one or more user classification conditions, one or more advertiser classification conditions, and/or one or more publisher classification conditions.

A user classification condition can comprise a classification tied to behavior or condition of a user of system 800. In some embodiments, the behavior of the user can be direct behavior, such as, for example, entry of a user input at a primary content control of the primary content of the content and/or entry of a user input at an advertisement control of an advertisement unit (e.g., an advertisement control of the advertisement unit as a whole, such as, for example, user control(s) 972 (FIG. 9), or an advertisement control of an individual interactive advertisement, such as for example, the user control(s) described above with respect to system 100 (FIG. 1), to user control(s) 272 (FIG. 2), to user control(s) 372 (FIG. 3), and/or to user control(s) 472 (FIG. 4)). Exemplary primary content controls can comprise a search field and/or a sorting (e.g., filtering) mechanism. The sorting mechanism can be configured to sort according to any suitable sorting category, including price, location, availability, brand, etc.

In these or other embodiments, for example, the advertisement classification(s) can comprise a classification for advertisement(s) related to the a search term entered into the search field, and/or a classification for advertisement(s) related to the sorting category selected at the sorting mechanism. For example, an exemplary advertisement classification can comprise advertisement(s) of one or more products having one or more particular price points and a corresponding classification condition triggering that advertisement classification can comprise operation by the user of system 800 of a sorting mechanism primary content control at the primary content to sort within a range of prices including those price points.

Further, in many embodiments, the behavior of the user can be indirect behavior, such as, for example, a content of the primary content requested by the user and/or a location or other condition (e.g., a physical condition, such as, for example, age, heart rate, weight, etc.) of the user or associated with the user (e.g., determined by a sensor of a user device of user device(s) 893 of the user). Further, user behavior can comprise historical user behavior (i.e., direct and/or indirect) of the user at web page(s) and/or software application(s) of system 800, and/or statistical user behavior (i.e., direct and/or indirect) of one or more other users (e.g., similar user(s)) of system 800.

In these or other embodiments, the advertisement classification(s) can comprise a classification for advertisement(s) related to the content of the primary content and/or a classification for advertisement(s) related to the location or another condition (e.g., a physical condition) of the user. For example, when the user classification condition(s) comprise an age of the user, the advertisement classification(s) can comprise a classification for advertisement(s) with adult content. Further, when the user classification condition(s) comprise a heart rate, weight, or other health condition of the user, the advertisement classification(s) can comprise a classification for advertisement(s) related to healthcare.

Meanwhile, an advertiser classification condition can comprise a classification condition established (e.g., provided) by an advertiser that is related to one or more of the advertisement(s) provided by advertisement module 821; and/or a publisher classification condition can comprise a classification condition established (e.g., provided) by a publisher of the advertisement(s) provided by advertisement module 821 through implementation of system 800. In these embodiments, the advertiser can also provide one or more advertisement classifications that correspond to each advertiser classification condition provided. Likewise, the publisher can also provide one or more advertisement classifications that correspond to each publisher classification condition provided. In other words, the advertiser and/or publisher can provide one or more of the advertisement classifications and can provide the classification condition(s) that correspond to each of the advertisement classifications provided. For purposes of clarity, the publisher may ultimately be responsible for establishing (e.g., determining) which classification condition(s) are actually implemented for a particular embodiment of system 800, which may or may not include advertiser classification condition(s) provided by one or more advertisers. However, in any event, advertisement classification conditions can correspond to advertisement classifications that inure to the benefit of the advertiser and publisher classification conditions can correspond to advertisement classifications that inure to the benefit of the publisher. Accordingly, in many embodiments, the publisher and the advertiser are different entities, though in some embodiments, the publisher and the advertiser can be the same entity.

For example, an advertiser can provide advertisement classifications that group advertisements of any predetermined category. Exemplary advertisement classifications can comprise classifications grouping advertisements according to product or service location, product or service brand, product size, product color, product or service price, product or service availability, service certifications, etc. Further exemplary advertisement classifications can comprise classifications grouping products or services based on temporal conditions, such as, for example, a remaining amount of time that products or services are on sale.

Likewise, the publisher can also provided publisher classifications that group advertisements of any predetermined category. Exemplary publisher classifications can comprise classifications grouping advertisements according to a time of day, a location of the advertising unit at the content, a greatest revenue potential for the publisher, etc.

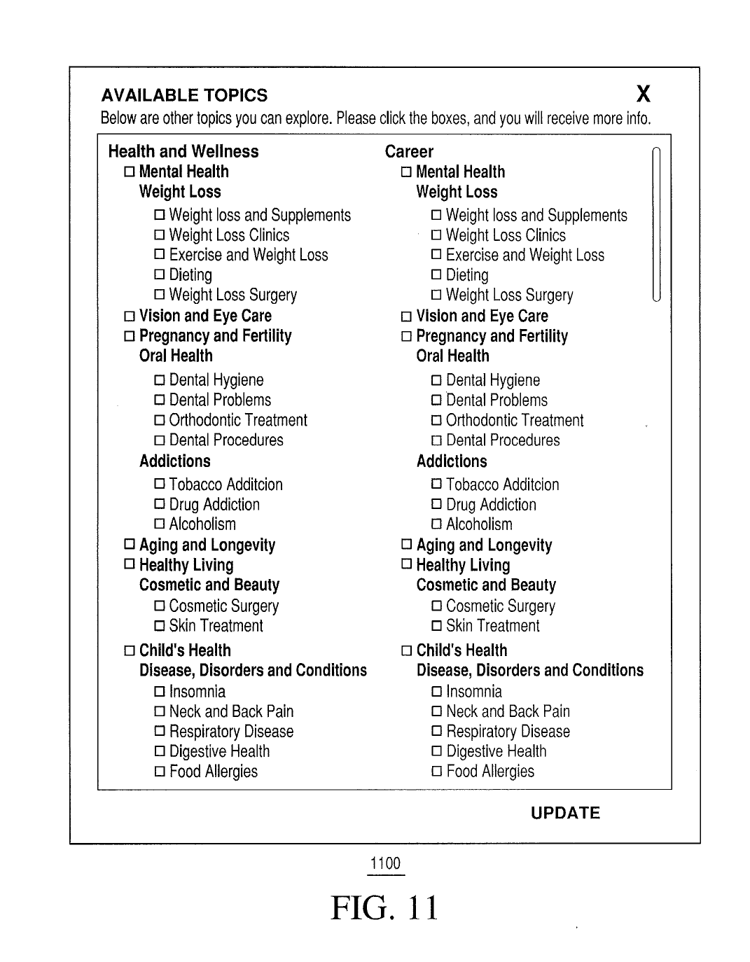

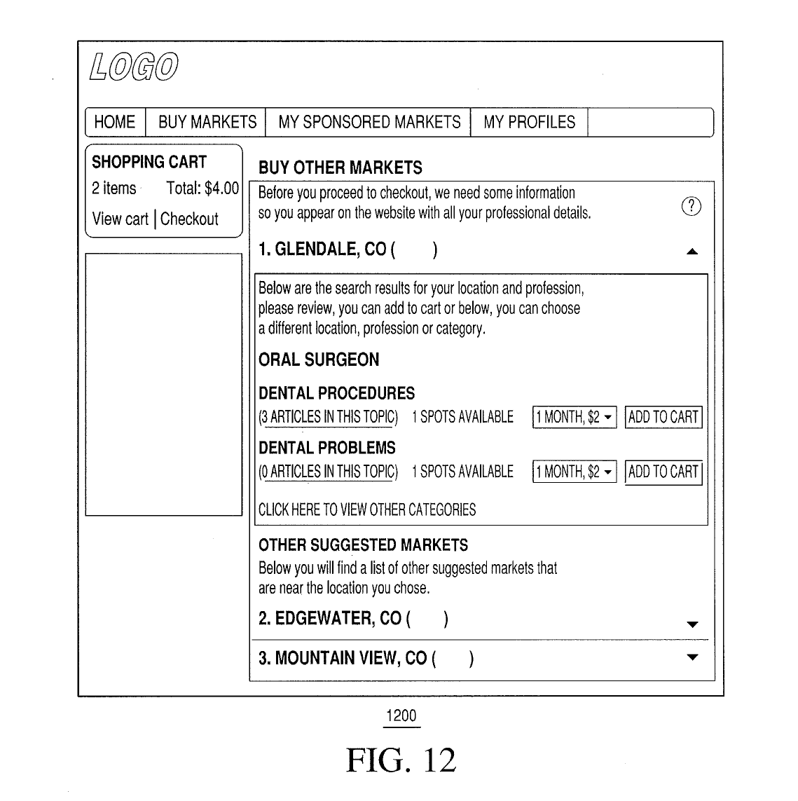

As discussed previously, in many embodiments, the publisher can determine the user classification conditions, the advertiser classification conditions, and/or the publisher classification conditions to implement for the classification condition(s). However, in other embodiments, the publisher can give deference to one or more advertisers and/or the user(s) to determine some or all of the classification condition(s). In these or other embodiments, the publisher can suggest advertiser classification condition(s) and/or user classification condition(s) from which the advertiser(s) and/or user(s) can choose, and/or the advertiser(s) and/or user(s) may be permitted to suggest their own advertiser classification condition(s) and/or user classification condition(s). Likewise, in some embodiments, the publisher can suggest one or more advertisement classification(s) to the advertiser(s) with which to associate their advertisements. In some embodiments, the user(s) and/or advertiser(s) of system 800 can select suggested user and/or advertiser classification condition(s) via an interface, such as, for example, a web page. Similarly, the advertiser(s) can select suggested advertisement classification(s) via an interface (e.g., interface 1100 (FIG. 11) and/or interface 1200 (FIG. 12)) similar to the interface for selecting suggested user and/or advertiser classification condition(s).

In order to determine to determine, based on the classification condition(s) being satisfied, what advertisement window(s) are provided at the one or more advertising unit(s), respectively, of the content (e.g., content 900 (FIG. 9)) that generation module 820 determines (e.g., generates) to provide to the user(s) of system 800 at user device(s) 893 (e.g., user device 890, user device 891, and/or user device 892), categorization module 841 can weight the classification conditions according to any suitable weighting criteria. For example, categorization module 841 can weight one or more classification condition genre(s) (e.g., user classification conditions, advertiser classification conditions, publisher classification conditions, etc.) higher than one or more other classification condition genre(s). Further, categorization module 841 can weight one or more classification condition(s) within a classification condition genre(s) higher than other classification condition(s) of that classification condition genre. Even further, categorization module 841 can weight one or more classification condition(s) of one classification condition genre higher than one or more classification condition(s) of another classification condition genre. The weight given to the various classification condition(s) can be static, with the weighting always remaining the same, or dynamic, with the weighting provided to the classification condition(s) changing based on one or more previous determinations of advertisement window(s) that are provided at the one or more advertising unit(s), respectively, of the content (e.g., content 900 (FIG. 9)) provided to the user(s) of system 800 at user device(s) 893 (e.g., user device 890, user device 891, and/or user device 892).

In these or other embodiments, categorization module 841 can determine that advertisement window(s) corresponding to advertisement classification(s) associated with satisfied classification condition(s) of highest weight are provided at the one or more advertising unit(s), respectively, of the content (e.g., content 900 (FIG. 9)) that generation module 820 determines (e.g., generates) to provide to the user(s) of system 800 at user device(s) 893 (e.g., user device 890, user device 891, and/or user device 892). The quantity of advertisement window(s) provided can be constrained by the size of the content (e.g., content 900 (FIG. 9)), the size of the advertisement unit(s) (advertisement unit(s) 970 (FIG. 9)) relative to the content, and the size of the advertisement window(s) (e.g., advertisement window(s) 976 (FIG. 9)) relative to the advertising unit(s).

Further, when the advertising unit(s) (e.g., advertising unit(s) 970 (FIG. 9)) comprise multiple advertisement window(s) (e.g., advertisement window(s) 976 (FIG. 9)), categorization module 841 can determine a format (e.g., an arrangement) of the advertisement window(s) at the advertising unit(s). The format of the advertisement window(s) can further depend on the classification condition(s).

When categorization module 841 establishes the appropriate advertisement window(s) for the content (e.g., content 900 (FIG. 9)), generation module 820 can determine (e.g., generate) the content (e.g., content 900 (FIG. 9)) to provide to the user(s) of system 800 at user device(s) 893 (e.g., user device 890, user device 891, and/or user device 892) in a similar manner to that of generation module 120 (FIG. 1) as described above. For example, content module 822 can be operable to provide (e.g., generate) the primary content (e.g., primary content 960 (FIG. 9)) of the content (e.g., content 900 (FIG. 9)) based upon the content element(s) stored at content index(es) 811. Meanwhile, structure module 823 can be operable to format the content (e.g., content 900 (FIG. 9)) provided to the user(s) of system 800 at user device(s) 893 (e.g., user device 890, user device 891, and/or user device 892) before the content is provided to the user(s) of system 800 at user device(s) 893 (e.g., user device 890, user device 891, and/or user device 892). In these or other embodiments, categorization module 841 can communicate with structure module 823 regarding the format to use for the content (e.g., content 900 (FIG. 9)) in line with the classification condition(s) that are satisfied. Further, web page creation module 824 and software application creation module 825 can configure the content provided to the user(s) of system 800 at user device(s) 893 (e.g., user device 890, user device 891, and/or user device 892) for presentation at one or more web pages or at a software application, respectively.

Likewise, categorization module 841 can communicate with modification module 840 to alter the advertising unit(s) (e.g., advertising unit(s) 970 (FIG. 9)) as the classification condition(s) change. Meanwhile, modification module 840 can also alter the primary content (e.g., primary content 960 (FIG. 9)) and any applicable interactive advertisement(s) of the advertisement window(s) (e.g., advertisement window(s) 976 (FIG. 9)) of the advertising unit(s) (e.g., advertising unit(s) 970 (FIG. 9)) in the manner described above with respect to system 100 (FIG. 1).

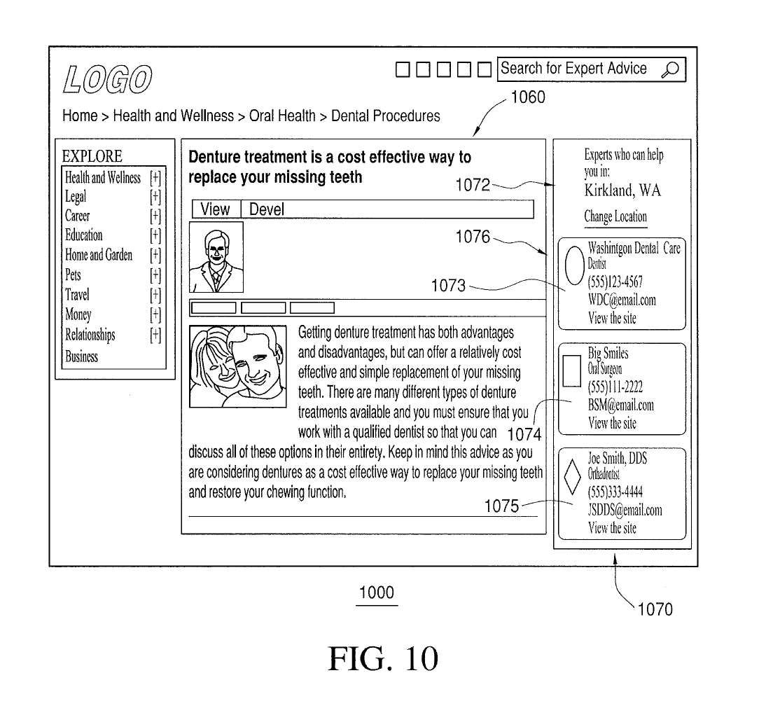

Turning ahead in the drawings, FIG. 10 illustrates exemplary content 1000, according to an embodiment. Content 1000 can be similar or identical to the content described above with respect to system 800 (FIG. 1) and/or to content 900 (FIG. 9). For example, content 1000 can comprise primary content 1060 and one or more advertising unit(s) 1070. Further, each advertising unit of advertising unit(s) 1070 can comprise one or more advertisement windows 1076 (e.g., advertisement window 1073, advertisement window 1074, and/or advertisement window 1075). In many embodiments, primary content 1060 can be similar or identical to primary content 960 (FIG. 9), and advertising unit(s) 1070 can be similar or identical to advertising unit(s) 970 (FIG. 9). In these or other embodiments, advertisement window(s) 1076 can be similar or identical to advertisement window(s) 976 (FIG. 9).

Further, FIG. 11 illustrates an exemplary interface 1100 at which advertiser(s) of system 800 (FIG. 8) can select suggested advertisement classification(s). For example, interface 1100 can comprise a web page at which the advertiser(s) can select one or more health related advertisement classification(s) with which to associate their advertisements. Meanwhile. FIG. 12 illustrates another exemplary interface 1200 at which advertiser(s) of system 800 (FIG. 8) can select suggested advertisement classification(s). In this example, interface 1200 can comprise a web page at which the advertiser(s) can select one or more location related advertisement classification(s) with which to associate their advertisements.

Referring again to FIG. 8, system 800 can be implemented to provide content at any suitable web page(s) and/or software application (e.g., mobile software application). In some specific examples, system 800 can be implemented to provide content at a web page where the content (e.g., content 900 (FIG. 9)) includes an advertising unit (e.g., advertising unit 970 (FIG. 9) having three advertisement windows (e.g., advertisement window(s) 976 (FIG. 9)) presenting advertisements for clothing, exercise, and food, respectively. The user control(s) for the advertising unit can read “for men,” “for women,” and “for children.” In these examples, the user of system 800 can select the user control “for men” causing the advertising unit to provide three new advertisement windows with advertisement(s) for advertisement classifications of men's clothing, men's exercise, and men's food. Further, system 800 can provide an additional advertisement window for advertisement(s) of the advertisement classification of men's grooming products at the advertising unit. In other examples, the user of system 800 can select the user control “for women” causing corresponding female-focused changes to the advertisement window(s) of the advertising unit and adding an advertisement window for advertisement(s) of the advertisement classification of female beauty products.

In other specific examples, a user of system 800 can be on the street level of the Empire State Building, and system 800 can provide the user with content (e.g., content 900 (FIG. 9)) at mobile application software of the user's user device of user device(s) 893. The content can include an advertising unit (e.g., advertising unit 970 (FIG. 9) with various advertisement windows (e.g., advertisement window(s) 976 (FIG. 9)) relating to different advertisement classifications of professional services (e.g., legal, medical, dental, etc.). As the user ascends to the 42^{nd} floor of the Empire States Building, system 800 can change the advertisement window(s) at the advertising unit so that the advertisement window(s) provide only advertisement(s) of advertisement classifications of professional service(s) available on that floor, such as, for example, criminal lawyers, personal injury lawyers, divorce lawyers, and forensic accountants.

In still other specific examples, a user of system 800 can be standing on a street facing a townhouse for sale in New York City while pointing their user device of user device(s) 893 at the townhouse. Sensors at the user device can detect direction and geographic location to provide advertisement window(s) (e.g., advertisement window(s) 976 (FIG. 9)) at the advertising unit (e.g., advertising unit(s) 970 (FIG. 9)) that provide advertisement(s) of advertisement classifications for real estate agents selling townhouses in New York City, real estate agents representing buyers of townhouses in New York City, a real estate agent currently selling the townhouse, and/or one or more real estate agents who previously represented buyers or sellers of the townhouse, respectively.

Further, in other specific examples, a user of system 800 can be walking near a new automobile and take a picture of the automobile. Accordingly, system 800 can provide content (e.g., content 900 (FIG. 9)) at a mobile software application with primary content (e.g., primary content 960 (FIG. 9)) related to specifications for the automobile and an advertising unit (e.g., advertising unit(s) 970 (FIG. 9)) including advertisement window(s) (e.g., advertisement window(s) 976 (FIG. 9)) providing advertisement(s) of advertisement classification(s) for nearby automobile dealers, used automobiles of the same make and model, new automobiles of a related make and model, respectively.

Meanwhile, in further specific examples, an advertiser (e.g., a hotel chain) of system 800 can provide a first advertisement classification including advertisement(s) for available rooms in the markets the advertiser serves. In these examples, the advertiser can have target room inventory and can want to run specials to sell out additional inventory. Accordingly, the advertiser can provide a second advertisement classification with only advertisement(s) for available rooms being on sale.

Further, in other specific examples, a publisher (i.e., operator) of system 800 can implement system 800 to provide content (e.g., content 900 (FIG. 9)) including one or more advertisement unit(s) (e.g., advertisement unit(s) 970 (FIG. 9)) including advertisement window(s) (e.g., advertisement window(s) 976 (FIG. 9)) associated with advertisement classifications for various types of dental professionals (e.g., dental, orthodontic, endodontic, etc.). However, where a user device of the user of system 800 includes a screen size and/or user preference that does not support all of the advertising unit(s), system 800 can provide content having a single advertising unit and a single advertisement window corresponding to an advertisement classification for advertisement(s) related to a current location of the user of system 800, without any regard for the type of professional advertised.

Some embodiments include a method of providing (e.g., manufacturing) a system. The system can be similar or identical to system 800 (FIG. 8). Notably, the method can comprise providing a content providing system. The content providing system can be similar or identical to content providing system 801 (FIG. 8).

Turning now to the next drawing, FIG. 13 illustrates a flow chart for an embodiment of a method 1300 of providing content to a user. In some embodiments, method 1300 can be considered a method of providing advertisements on a web page or providing advertisements in a software application. In various embodiments, method 1300 can also be considered a method of distributing content or advertisements. Method 1300 is merely exemplary and is not limited to the embodiments presented herein. Method 1300 can be employed in many different embodiments or examples not specifically depicted or described herein. In some embodiments, the activities, the procedures, and/or the processes of method 1300 can be performed in the order presented. In other embodiments, the activities, the procedures, and/or the processes of method 1300 can be performed in any other suitable order. In still other embodiments, one or more of the activities, the procedures, and/or the processes in method 1300 can be combined or skipped. Meanwhile, one or more of the activities of method 1300 can comprise computer instructions configured to be operated at a processing module of a computer system, and the computer system can be similar or identical to computer system 600 (FIG. 6).

In many embodiments, method 1300 can comprise an activity 1301 of establishing a first advertisement classification and an activity 1302 of establishing a second advertisement classification. The first advertisement classification and/or the second advertisement classification can be similar or identical to the advertisement classification(s) described above with respect to system 800 (FIG. 8). In these or other embodiments, method 1300 can comprise any suitable additional activities of establishing one or more additional advertisement classifications.

In many embodiments, method 1300 can comprise an activity 1303 of associating a first advertisement with the first advertisement classification so that one or more first classification advertisements comprise the first advertisement. In some embodiments, activity 1303 can be performed approximately simultaneously with or after activity 1301 and/or activity 1302.

In many embodiments, method 1300 can comprise an activity 1304 of associating a second advertisement with the second advertisement classification so that one or more second classification advertisements comprise the second advertisement. In some embodiments, activity 1304 can be performed approximately simultaneously with or after activity 1301 and/or activity 1302. In some embodiments, activity 1303 can be performed before activity 1304, and vice versa. In other embodiments, activity 1303 and activity 1304 can be performed approximately simultaneously. In these or other embodiments, the first advertisement and/or the second advertisement can be similar or identical to the advertisement(s) described above with respect to system 800 (FIG. 8). Further, in these or other embodiments, method 1300 can comprise any suitable additional activities of associating advertisement(s) with advertisement classification(s). Performing activity 1303, activity 1304, and/or any other activities of associating advertisement(s) with advertisement classification(s) can be similar or identical to associating advertisement(s) with advertisement classification(s) as described above with respect to system 800 (FIG. 8).

In many embodiments, method 1300 can comprise an activity 1305 of receiving a request from a user for primary content (e.g., at web page, at a software application, etc.). In some embodiments, activity 1305 can be omitted, such as, for example, in many embodiments when the activity 1306 is implemented to provide the primary content at a software application.

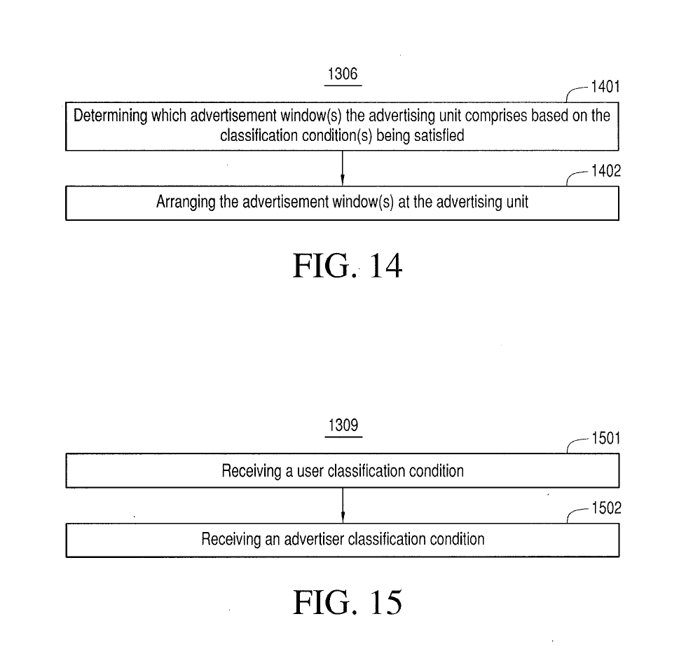

In many embodiments, method 1300 can comprise an activity 1306 of providing the user with content comprising the primary content and an advertising unit comprising one or more advertisement window(s) (e.g., at the web page, at the software application, etc.). In many embodiments, activity 1306 can be performed after activity 1305. The content can be similar or identical to the content described above with respect to system 800 (FIG. 8), to content 900 (F1G. 9), and/or content 1000 (FIG. 10). The advertisement window(s) can be similar or identical to the advertisement window(s) described above with respect to system 800 (FIG. 8), to advertisement window(s) 976 (FIG. 9), and/or advertisement window(s) 1076 (FIG. 10). FIG. 14 illustrates an exemplary activity 1306, according to the embodiment of FIG. 13.

For example, activity 1306 can comprise an activity 1401 of determining which advertisement window(s) the advertising unit comprises based on the classification condition(s) being satisfied. Performing activity 1401 can be similar or identical to determining which advertisement window(s) the advertising unit comprises based on the classification condition(s) being satisfied as described above with respect to system 800 (FIG. 8).

Further, activity 1306 can comprise an activity 1402 of arranging the advertisement window(s) at the advertising unit. Performing activity 1402 can be similar or identical to arranging the advertisement window(s) at the advertising unit as described above with respect to system 800 (FIG. 8).

Turning back now to FIG. 13, in some embodiments, method 1300 can comprise an activity 1307 of receiving first advertising content of the first advertisement and/or activity 1308 of receiving second advertising content of the second advertisement. The first advertising content and/or the second advertising content can be similar or identical to the advertising content described above with respect to system 100 (FIG. 1) and/or system 800 (FIG. 8). In these or other embodiments, method 1300 can comprise any suitable additional activities of receiving advertising content. In many embodiments, activity 1307, activity 1308, and any additional activities of receiving advertising content can be performed before one or more of activities 1301-1306.

In many embodiments, method 1300 can comprise an activity 1309 of establishing the at least one classification condition (e.g., a user classification condition, an advertiser classification condition, a publisher classification condition, etc.). In some embodiments, performing activity 1309 can be similar or identical to establishing the at least one classification condition (e.g., a user classification condition, an advertiser classification condition, a publisher classification condition, etc.) as described above with respect to system 800 (FIG. 8). In many embodiments, activity 1309 can be performed before activity 1306. FIG. 15 illustrates an exemplary activity 1309, according to the embodiment of FIG. 13.

For example, activity 1309 can comprise an activity 1501 of receiving a user classification condition (e.g., from a user or an advertiser). Further, activity 1309 can comprise an activity 1502 of receiving an advertiser classification condition (e.g., from an advertiser). In these or other embodiments, activity 1501 and/or activity 1502 can be repeated any suitable number of times to receive additional user classification condition(s) and/or advertiser classification condition(s).

Turning again back to FIG. 13, in many embodiments, method 1300 can comprise an activity 1310 of receiving at least one advertisement classification (e.g., the first advertisement classification, the second advertisement classification, etc.). In these or other embodiments, activity 1310 can comprise receiving at least one advertisement classification (e.g., the first advertisement classification, the second advertisement classification, etc.) from one or more advertisers. Performing activity 1310 can be similar or identical to activity to receiving the advertisement classification(s) as described above with respect to system 800 (FIG. 8). In many embodiments, activity 1310 can be performed before activity 1306.

In many embodiments, method 1300 can comprise an activity 1311 of weighting the classification condition(s) when the classification condition(s) comprise multiple classification conditions. In some embodiments, performing activity 1311 can be similar or identical to weighting the classification condition(s) when the classification condition(s) comprise multiple classification conditions as described above with respect to system 800 (FIG. 8). In many embodiments, activity 1311 can be performed as part of activity 1306 and/or activity 1401 (FIG. 14).

Although the invention has been described with reference to specific embodiments, it will be understood by those skilled in the art that various changes may be made without departing from the spirit or scope of the invention. Accordingly, the disclosure of embodiments of the invention is intended to be illustrative of the scope of the invention and is not intended to be limiting. It is intended that the scope of the invention shall be limited only to the extent required by the appended claims. For example, to one of ordinary skill in the art, it will be readily apparent that activities 570-582 of method 500 (FIG. 5) and activities 1301-1311 of method 1300 (FIG. 13) can be comprised of many different activities, processes, and/or procedures, can be performed by many different modules and in many different orders, that any element of FIGS. 1-15 can be modified, and that the foregoing discussion of certain of these embodiments does not necessarily represent a complete description of all possible embodiments.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system for providing one or more web pages to one or more users, each of the one or more web pages comprising primary content and one or more interactive advertisements, the system comprising:
a processor; and
a non-transitory memory storage device operable to store computer instructions configured to run on the processor and perform acts of:
generating the one or more interactive advertisements based upon one or more advertising elements;
generating the primary content based upon one or more primary content elements;
generating the one or more web pages based upon the primary content and the one or more interactive advertisements;
communicating with the one or more users to receive one or more requests from the one or more users; and
based upon the one or more requests from the one or more users, altering at least one of: a content of the one or more interactive advertisements, a format of the one or more interactive advertisements, a content of the primary content, or a format of the primary content.

2. The system of claim 1, wherein:
the acts further comprise determining additional elements to provide to the one or more users based upon the one or more requests from the one or more users; and
the additional elements comprise at least one of (i) additional contents elements from the one or more primary content elements or (ii) additional advertisements from the one or more advertisement elements.

3. The system of claim 1, further comprising:
at least one content index configured to store the one or more primary content elements; and
at least one advertisement index configured to store the one or more advertising elements;
wherein the acts further comprise:
retrieving the one or more primary content elements from the at least one content index; and
retrieving the one or more advertising elements from the at least one advertisement index.

4. The system of claim 1, wherein the acts further comprise:
generating other primary content for at least one software application based upon the primary content and the one or more interactive advertisements.

5. The system of claim 1, wherein:
the altering the at least one of: the content of the one or more interactive advertisements, the format of the one or more interactive advertisements, the content of the primary content, or the format of the primary content occurs without the web page being reloaded, refreshed, or resent.

6. The system of claim 1, wherein:
the acts further comprise generating the one or more interactive advertisements according to at least one user control; and
the at least one user control is configured to direct the altering the at least one of: the content of the one or more interactive advertisements, the format of the one or more interactive advertisements, the content of the primary content, or the format of the primary content.

7. The system of claim 6, wherein:
the at least one user control is configured to respond to at least one of:
a clicking of a computer mouse button by the one or more users;
interaction with a touch screen or a trackball;
a pressing of a keyboard button by the one or more users;
a change in position of a computing device displaying the one or more web pages;
a voice command by the one or more users;
a hand movement by the one or more users;
an eye movement by the one or more users;
an environmental change;
an entry at a search field by the one or more users; or
a physical condition of the one or more users.

8. The system of claim 6, wherein the acts further comprise:
altering the at least one user control without reloading, refreshing, or resending the web page.

9. A method for providing advertisements on a web page, at least part of the method being implemented via execution of one or more computer instructions configured to run at a processor, the method comprising:
executing one or more first computer instructions configured to receive a first request from a user for the web page;
executing one or more second computer instructions configured to provide the user with the web page, the web page comprising:
primary content; and
one or more interactive advertisements;
executing one or more third computer instructions configured to receive a second request from the user to alter a first one of the one or more interactive advertisements; and
after executing the one or more third computer instructions, executing one or more fourth computer instructions configured to alter the first one of the one or more interactive advertisements, the first one of the one or more interactive advertisements comprising content;
wherein:
the one or more computer instructions comprise the one or more first computer instructions, the one or more second computer instructions, the one or more third computer instructions, and the one or more fourth computer instructions.

10. The method of claim 9, further comprising:
after executing the one or more third computer instructions, executing one or more fifth computer instructions configured to perform a query of at least one advertising content index to determine revised content for the first one of the one or more interactive advertisements;
wherein:
the second request from the user to alter the first one of the one or more interactive advertisements comprises a request to alter the content of the first one of the one or more interactive advertisements;
executing the one or more fourth computer instructions comprises:
executing one or more sixth computer instructions configured to alter the first one of the one or more interactive advertisements to include the revised content without refreshing, reloading, or resending the web page and without changing the primary content of the web page;
and
the one or more computer instructions comprise the one or more fifth computer instructions.

11. The method of claim 9, wherein:
the second request from the user to alter the first one of the one or more interactive advertisements comprises a request to reformat the content of the first one of the one or more interactive advertisements; and
executing the one or more fourth computer instructions comprises:
executing one or more fifth computer instructions configured to reformat the content of the first one of the one or more interactive advertisements without refreshing, reloading, or resending the web page and without changing the primary content of the web page.

12. The method of claim 9, further comprising:
executing one or more fifth computer instructions configured to alter the primary content based on the second request of the user without refreshing, reloading, or resending the web page;
wherein:
the one or more computer instructions comprise the one or more fifth computer instructions.

13. The method of claim 9, wherein:
the one or more interactive advertisements comprise one or more first user controls.

14. The method of claim 13, wherein:
executing the one or more third computer instructions comprises:
executing one or more fifth computer instructions configured to receive the second request from the user to alter the first one of the one or more interactive advertisements;
and
the second request is generated by the one or more first user controls.

15. The method of claim 13, further comprising:
after executing the one or more third computer instructions, executing one or more fifth computer instructions configured to perform a query of at least one second advertising content index to determine one or more second user controls for the first one of the one or more interactive advertisements,
wherein:
executing the one or more fourth computer instructions comprises:
executing one or more sixth computer instructions configured to replace the one or more first user controls in the first one of the one or more interactive advertisements with the one or more second user controls without refreshing, reloading, or resending the web page and without changing the primary content of the web page;
and
the one or more computer instructions comprise the one or more fifth computer instructions.

16. The method of claim 9, wherein:
the web page comprises one or more first user controls.

17. The method of claim 16, wherein:
executing the one or more third computer instructions comprises:
executing one or more fifth computer instructions configured to receive the second request from the user to alter the first one of the one or more interactive advertisements;
and
the second request was generated by the one or more first user controls.

18. The method of claim 9, wherein:
executing the one or more second computer instructions comprises:
executing one or more fifth computer instructions configured to acquire the primary content;
executing one or more sixth computer instructions configured to acquire the one or more interactive advertisements;
executing one or more seventh computer instructions configured to organize the primary content and the one or more interactive advertisements into the web page; and
communicating the web page to the user;
wherein:
the web page includes the one or more fourth computer instructions configured to alter the first one of the one or more interactive advertisements.

19. The method of claim 9, further comprising:
receiving a payment from one or more advertisers for the one or more interactive advertisements.

20. A method for providing advertisements at a mobile software application, at least part of the method being implemented via execution of one or more computer instructions configured to run at a processor, and the mobile software application including primary content and one or more interactive advertisements, the method comprising:
executing one or more first computer instructions configured to receive a request from the user to alter a first one of the one or more interactive advertisements; and
after executing the one or more first computer instructions, executing one or more second computer instructions configured to alter the first one of the one or more interactive advertisements, the first one of the one or more interactive advertisements comprising a content;
wherein:
the one or more computer instructions comprise the one or more first computer instructions and the one or more second computer instructions.

21. The method of claim 20, further comprising:
after executing the one or more first computer instructions, executing one or more third computer instructions configured to perform a query of at least one advertising content index to determine revised content for the first one of the one or more interactive advertisements;
wherein:
the request from the user to alter the first one of the one or more interactive advertisements comprises a request to alter the content of the first one of the one or more interactive advertisements;
executing the one or more second computer instructions comprises:
executing one or more fourth computer instructions configured to alter the first one of the one or more interactive advertisements to include the revised content;
and
the one or more computer instructions comprise the one or more third computer instructions.

22. The method of claim 20, wherein:
the request from the user to alter the first one of the one or more interactive advertisements comprises a request to reformat the content of the first one of the one or more interactive advertisements; and
executing the one or more second computer instructions comprises:
executing one or more third computer instructions configured to reformat the content of first one of the one or more interactive advertisements.

23. The method of claim 20, further comprising:
executing one or more third computer instructions configured to alter the primary content based on the request of the user to alter the first one of the one or more interactive advertisements;
wherein:
the one or more computer instructions comprise the one or more third computer instructions.

24. The method of claim 20, wherein:
the one or more interactive advertisements comprise one or more user controls.
